(19) United States
(12) Patent Application Publication
(10) Pub. No.: US 2026/0030634 A1
(43) Pub. Date: Jan. 29, 2026

(54) SALES CYCLE MANAGEMENT SYSTEMS AND METHODS

(71) Applicant: DeLorean Artificial Intelligence, Inc., Palm Beach, FL (US)

(72) Inventors: Severence M. MacLaughlin, Palm Beach, FL (US); Ram Prasad Bora, Palm Beach, FL (US); Dhiraj Sharma, Palm Beach, FL (US)

(21) Appl. No.: 18/786,540

(22) Filed: Jul. 28, 2024

(51) Int. Cl. G06Q 30/015; G06F 16/28; G06Q 30/02

(52) U.S. Cl. CPC G06Q 30/015; G06F 16/285; G06Q 30/0281

(57) ABSTRACT

Techniques for cycle management including: determining, based on historical unstructured CRM data, a document model to determine document attributes of a set of documents; determining, based on historical structured CRM data, a stage prediction model to determine attributes of a current sales cycle based on a current sales cycle stage and current document attributes; determining, based on current sales cycle structured data, a current stage of the current sales cycle; determining, based on application of current sales cycle unstructured data to the document model, a current set of attributes for the current sales cycle; and determining, based on application of the current stage of the current sales cycle and the current set of attributes for the current sales cycle to the stage prediction model, a predicted outcome for the current sales cycle.

### FIELD

Embodiments relate generally to facilitating progress and completion of process cycles and more particularly to systems and methods for assessing and implementing actions to promote progress along a cycle pathway.

### BACKGROUND

Sales cycle management refers to the process of overseeing and guiding the journey a potential customer takes from initial contact to final purchase. It often involves a series of stages such as initial contact, discussion and negotiations, sale, and follow-up. Effective sales cycle management requires understanding customer needs, building relationships, providing solutions, and managing interactions to ultimately drive sales revenue and foster long-term customer satisfaction. For example, sales cycle management in the context of a software company selling a project management tool may involve a sales team identifying and engaging potential customers in need of a project management solution, conducting rounds of discussion to determine a fit between the customer and the tool, conducting rounds of negotiation to agree on terms for purchase, conducting a closing to finalize purchase, and providing the product and post-sale support, such as onboarding, training, and ongoing assistance to ensure the customer derives value from the software. Accordingly, sales cycles often include unique pathways from start to finish, which can involve various types of interactions between providers and customers.

### SUMMARY

Sales cycles (or “deals”) can vary significantly from one customer to another and from one product to another. It's often a dynamic process that demands adaptability and personalized approaches. Certain techniques for sales cycle management leverage advanced CRM (Customer Relationship Management) systems, data analytics, and automation tools to streamline processes, personalize interactions, and optimize sales performance. However, despite these advancements, shortcomings persist. These include, for example, difficulty in accurately predicting buyer behavior and challenges in adapting to rapidly evolving market dynamics. Moreover, the variability of sales cycles poses challenges to accurately identifying where a sales project stands and predicting its eventual outcome. Factors such as fluctuating customer needs, competitive landscapes, and internal decision-making processes can obscure the path forward. Accordingly, effective sales cycle management often requires a delicate and unique balance of leveraging technology while prioritizing authentic customer engagement and adaptability.

In some instances, sales organizations engage in data collection and assessment to understand a sales cycle. For example, organizations sometimes endeavor to collect, analyze, and model data to gain insights into customer behavior, market trends, and sales performance. However, these efforts often encounter challenges due to variations in data volume, variety, and quality. Limited volumes of data may not provide a comprehensive understanding, while data of varying types and quality can introduce inconsistencies and inaccuracies into analyses. Additionally, source data residing in different formats, including structured and unstructured data, further complicates the process, as reconciling and integrating diverse datasets can be arduous. Consequently, organizations may benefit from invest in robust data management strategies, employ advanced analytics tools, and implement data quality initiatives to effectively harness the potential of their data for accurate modeling and informed decision-making. By utilizing strategies, tools, and analytics to streamline and optimize each stage of a sales cycle, such as those described here, businesses can enhance efficiency, maximize sales opportunities, and cultivate lasting customer loyalty.

Provided in some embodiments are sales cycle management techniques that are operable to assess sales cycle data, determine predicted outcomes for a sales cycle, and provide recommendations for actions to be taken to, for example, improve the outcome of the cycle. For example, a sales cycle management system may include a CRM engine that is operable to process historical CRM data to generate CRM models that are operable to generate predicted outcomes and recommendations for a sales cycle based on application of current CRM data to the CRM models. As described, data may be applied to one or more of these models to generate relevant determinations and information, such as cycle outcome predictions and recommended actions to be taken (e.g., “next best actions”).

In some embodiments, CRM models include a document model that is operable to determine document attributes based on application of unstructured CRM data, such as text of communications during a sales cycle, and a stage prediction model that is operable to predict a stage to which a sales cycle will advance based on application of a current stage identification and document attributes for a corresponding current set of documents, such as recent text of communications (e.g., e-mail communications or the like) captured during a current stage, or other recent stage(s), of the sales cycle.

In some embodiments, a document model is generated by way of an unstructured pathway that involves processing of unstructured CRM data in a combination of unsupervised and supervised learning. For example, a document model may be trained, or otherwise generated, based on models generated by way of a supervised learning process (e.g., that includes supervised, e.g., manual, labeling of document stages for documents of historical unstructured CRM data) and based on document cluster attributes and sentiments generated by way of an unsupervised learning process (e.g., that includes unsupervised document clustering and sentiment analysis for the documents of historical unstructured CRM data).

In some embodiments, a stage identification model used for stage identification is generated by way of a structured pathway that involves processing of structured CRM data. For example, a stage identification model may be trained, or otherwise generated, based on historical structured CRM data, such as a table of sales cycle information that includes sets of attribute information, such as attribute-value pairs for customer identifier, salesperson identifier, product identifier, current stage, stages reached, estimated value of the opportunity, anticipated close date, number of communications or interactions in each stage, last type/date of activity, or the like. Such a model may, for example, include a mapping of sales cycle attributes to sales cycle stages.

In some embodiments, a stage prediction model is generated based on a stage identification model generated based on CRM data and associated sentiments determined for the CRM data. For example, a stage prediction model for a CRM sales cycle may be trained, or otherwise generated, based on a stage identification model generated based on historical structured CRM data for a given period of time, such as a mapping of sales cycle attributes to sales cycle stages for the given period of time, and based on document sentiments determined based on historical unstructured CRM data for the given period of time, such as text of communications captured during stages of the sales cycle of the given period of time.

In some embodiments, a current set of document attributes is determined based on application of current unstructured CRM data to a document model. For example, a current set of unstructured CRM data may include a set of documents, with each document including text of communications captured during stages of the sales cycle of the given period of time, where vectors representing the documents are generated by way of a vectorization operation, and the resulting vectors are applied to a document model to generate a set of current document attributes.

In some embodiments, a current stage is identified based on application of current structured CRM data to a stage identification model. For example, current structured CRM data, such as a table of sale cycle information identifying attribute-value pairs for a current sales cycle, may be applied to a stage identification model to identify a current stage of the sales cycle.

In some embodiments, an outcome prediction is generated based on application of a current set of document attributes and a current stage to a stage prediction model. For example, a current set of document attributes (e.g., identified using a document model) and a current stage (e.g., identified using a stage identification model) may be applied to a stage prediction model to generate an output that includes an outcome prediction that indicates a stage that the sales cycle is expected to reach, such as initial contact, document sharing, letter of intent, proposal, negotiations, on-hold/lost/won, or the like. The outcome prediction may include other relevant data, such as a current win/loss percentage, indications of aspects that are key deal progress drivers, a next best stage prediction, a final deal stage prediction, a directionality prediction, a next best sales representative to handle, a next best capability, dela gap analysis, conversion and intervention recommendations, or the like.

In some embodiments, an outcome prediction includes or is otherwise accompanied by a CRM plan that is expected to generate an improved outcome. For example, where an outcome prediction determines that the sales cycle will reach a given stage that is short of a win, the outcome prediction may indicate a given stage that the sales cycle is predicted to reach and a CRM plan that defines one or more recommended “next best actions” to be taken to enhance the likelihood of the sales cycle advancing past the given stage, to a win scenario. In some embodiments, a CRM plan is executed in an effort to generate an improved outcome. For example, CRM personnel, a CRM engine, or another entity, may perform some or all the one or more recommended “next best actions” of a CRM plan in an effort to advance the sales cycle past the given stage and to a win scenario in an efficient and effective manner.

Provided in some embodiments is a sales management process including a model generation process that includes the following: (1) generating, based on structured CRM data, a historical structured CRM dataset corresponding to a set of historical sales cycles, where the historical structured CRM dataset is indicative of attributes and stages of the set of historical sales cycles; (2) determining, based on the historical structured CRM dataset, a stage identification model operable to identify a current stage of a sales cycle based on structured CRM data; (3) generating, based on the unstructured CRM data, a historical unstructured CRM dataset corresponding to the set of historical sales cycles, the historical unstructured CRM dataset including a set of documents that each include textual data corresponding to electronic communications between one or more clients and one or more providers associated with the set of historical sales cycles; (4) determining, for each document of the set of documents (a) a stage of a sales cycle associated with the document (e.g., where the stage of the sales cycle associated with a document is determined based on a supervised learning process that includes labeling of the document with the associated stage of the sales cycle); and (b) a numerical representation of the document (e.g., where the numerical representation of the document includes a vector determined by vectorization of the textual data of the document); (5) determining, based on the documents, a document-to-stage model configured to determine a stage of a sales cycle based on textual data of documents associated with the sales cycle (e.g., where the document-to-stage model includes one or more of: a document-to-vector model operable to determine vectors based on textual data of one or more documents; and a vector-to-stage model operable to determine a stage based on vectors including numerical representations of documents); (6) determining, for each document, a sentiment of the document; (7) determining, based on the numerical representations of the documents, document clusters; (8) determining, for each document cluster of the document clusters, a cluster word set (e.g., a word cloud) for the document cluster; (9) determining, for each document cluster of the document clusters based on the cluster word set for the document cluster, cluster attributes (e.g., where the cluster attributes for a document cluster include significant words of the cluster word set for the document cluster); (10) determining, based on some or all of (a) the one or more stage models, (b) the cluster attributes, and (c) the sentiments for the documents, a document model operable to determine current document attributes based on numerical representations of a set of current documents (e.g., where the numerical representations of the set of current documents include vectors representing the set of current documents); and (11) determining, based on (a) stage identification model (e.g., a stage attribute mapping) and (b) the sentiments for the documents, a stage prediction model operable to determine attributes of a current sales cycle based on (i) a current sales cycle stage and (ii) current document attributes. In some embodiments, a sales management process includes a sales cycle modeling process that includes the following: (1) obtaining a current CRM sales cycle dataset that includes: (a) current sales cycle structured data indicative of attributes of a current stage of a current sales cycles; and (b) current sales cycle unstructured data that includes current documents including textual data corresponding to current electronic communications between one or more clients and one or more providers of the current sales cycle; (2) determining, based on application of the current sales cycle structured data to the stage identification model, a current stage of the current sales cycle; (3) determining, based on the current sales cycle unstructured data, a current set of numerical representations of the current set of documents (e.g., where the numerical representations of the current set of documents include vectors determined by way of vectorization of the textual data of the current set of documents); (4) determining, based on application of the set of the current set of numerical representations of the current set of documents to the document model, a current set of attributes for the current sales cycle; and (5) determining, based on application of (a) the current stage of the current sales cycle and (b) the current set of attributes for the current sales cycle to the stage prediction model, a predicted outcome for the current sales cycle (e.g., where the predicted outcome is indicative of a stage or other portion of a sales cycle that the current sales cycle is predicted to reach). In some embodiments, a sales cycle modeling process includes determining a CRM plan to generate an improved outcome, which may, for example, be provided along with the predicted outcome. In certain embodiments, the CRM plan defines a sales cycle action to be taken, and the sales management process includes executing, based on the CRM plan, the sales cycle action.

Although certain embodiments are described in the context of a given sales environment, such as software sales, and including a given set of stages and source data, embodiments may be employed in any suitable context, such as with various cycles, products, stages, and source data.

### BRIEF DESCRIPTION OF THE DRAWINGS

FIG. 1 is diagram that illustrates a sales cycle environment in accordance with one or more embodiments.

FIGS. 2A and 2B provide a flow diagram that illustrates operational aspects of a sales management system in accordance with one or more embodiments.

FIG. 3 is a diagram that illustrates a sales cycle progression in accordance with one or more embodiments.

FIG. 4 is a diagram that illustrates document content in accordance with one or more embodiments.

FIG. 5 is a diagram that illustrates pre-processed document content in accordance with one or more embodiments.

FIG. 6 is a diagram that illustrates a cluster definition in accordance with one or more embodiments.

FIG. 7 is a diagram that illustrates a cluster map in accordance with one or more embodiments.

FIG. 8 is a diagram that illustrates a cluster distribution in accordance with one or more embodiments.

FIG. 9 is a diagram that illustrates document cluster probabilities and assignments in accordance with one or more embodiments.

FIG. 10 is a diagram that illustrates a cluster word set in accordance with one or more embodiments.

FIG. 11 is a diagram that illustrates a cluster word distribution in accordance with one or more embodiments.

FIG. 12 is a diagram that illustrates significant word sets of clusters in accordance with one or more embodiments.

FIG. 13 is a diagram that illustrates document sentiments in accordance with one or more embodiments.

FIG. 14 is a diagram that illustrates a stage-attribute mapping in accordance with one or more embodiments.

FIG. 15 is a diagram that illustrates a management dashboard in accordance with one or more embodiments.

FIG. 16 is a flowchart diagram that illustrates a method of determining cycle models in accordance with one or more embodiments.

FIG. 17 is a flowchart diagram that illustrates a method of managing cycles in accordance with one or more embodiments.

FIG. 18 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Provided are embodiments for sales cycle management that are operable to assess sales cycle data, determine predicted outcomes for a sales cycle, and provide recommendations for actions to be taken to, for example, improve the outcome of the cycle. For example, a sales cycle management system may include a CRM engine that is operable to process historical CRM data to generate CRM models that are operable to generate predicted outcomes and recommendations for a sales cycle based on application of current CRM data to the CRM models. As described, data may be applied to one or more of these models to generate relevant determinations and information, such as cycle outcome predictions and recommended actions to be taken (e.g., “next best actions”).

In some embodiments, CRM models include a document model that is operable to determine document attributes based on application of unstructured CRM data, such as text of communications during a sales cycle, and a stage prediction model that is operable to predict a stage to which a sales cycle will advance based on application of a current stage identification and document attributes for a corresponding current set of documents, such as recent text of communications (e.g., e-mail communications or the like) captured during a current stage, or other recent stage(s), of the sales cycle.

In some embodiments, a document model is generated by way of an unstructured pathway that involves processing of unstructured CRM data in a combination of unsupervised and supervised learning. For example, a document model may be trained, or otherwise generated, based on models generated by way of a supervised learning process (e.g., that includes supervised, e.g., manual, labeling of document stages for documents of historical unstructured CRM data) and based on document cluster attributes and sentiments generated by way of an unsupervised learning process (e.g., that includes unsupervised document clustering and sentiment analysis for the documents of historical unstructured CRM data).

In some embodiments, a stage identification model used for stage identification is generated by way of a structured pathway that involves processing of structured CRM data. For example, a stage identification model may be trained, or otherwise generated, based on historical structured CRM data, such as a table of sales cycle information that includes sets of attribute information, such as attribute-value pairs for customer identifier, salesperson identifier, product identifier, current stage, stages reached, estimated value of the opportunity, anticipated close date, number of communications or interactions in each stage, last type/date of activity, or the like. Such a model may, for example, include a mapping of sales cycle attributes to sales cycle stages.

In some embodiments, a stage prediction model is generated based on a stage identification model generated based on CRM data and associated sentiments determined for the CRM data. For example, a stage prediction model for a CRM sales cycle may be trained, or otherwise generated, based on a stage identification model generated based on historical structured CRM data for a given period of time, such as a mapping of sales cycle attributes to sales cycle stages for the given period of time, and based on document sentiments determined based on historical unstructured CRM data for the given period of time, such as text of communications captured during stages of the sales cycle of the given period of time.

In some embodiments, a current set of document attributes is determined based on application of current unstructured CRM data to a document model. For example, a current set of unstructured CRM data may include a set of documents, with each document including text of communications captured during stages of the sales cycle of the given period of time, where vectors representing the documents are generated by way of a vectorization operation, and the resulting vectors are applied to a document model to generate a set of current document attributes.

In some embodiments, a current stage is identified based on application of current structured CRM data to a stage identification model. For example, current structured CRM data, such as a table of sale cycle information identifying attribute-value pairs for a current sales cycle, may be applied to a stage identification model to identify a current stage of the sales cycle.

In some embodiments, an outcome prediction is generated based on application of a current set of document attributes and a current stage to a stage prediction model. For example, a current set of document attributes (e.g., identified using a document model) and a current stage (e.g., identified using a stage identification model) may be applied to a stage prediction model to generate an output that includes an outcome prediction that indicates a stage that the sales cycle is expected to reach, such as initial contact, document sharing, letter of intent, proposal, negotiations, on-hold/lost/won, or the like. The outcome prediction may include other relevant data, such as a current win/loss percentage, indications of aspects that are key deal progress drivers, a next best stage prediction, a final deal stage prediction, a directionality prediction, a next best sales representative to handle, a next best capability, dela gap analysis, conversion and intervention recommendations, or the like.

In some embodiments, an outcome prediction includes or is otherwise accompanied by a CRM plan that is expected to generate an improved outcome. For example, where an outcome prediction determines that the sales cycle will reach a given stage that is short of a win, the outcome prediction may indicate a given stage that the sales cycle is predicted to reach and a CRM plan that defines one or more recommended “next best actions” to be taken to enhance the likelihood of the sales cycle advancing past the given stage, to a win scenario. In some embodiments, a CRM plan is executed in an effort to generate an improved outcome. For example, CRM personnel, a CRM engine, or another entity, may perform some or all the one or more recommended “next best actions” of a CRM plan in an effort to advance the sales cycle past the given stage and to a win scenario in an efficient and effective manner.

Provided in some embodiments is a sales management process including a model generation process that includes the following: (1) generating, based on structured CRM data, a historical structured CRM dataset corresponding to a set of historical sales cycles, where the historical structured CRM dataset is indicative of attributes and stages of the set of historical sales cycles; (2) determining, based on the historical structured CRM dataset, a stage identification model operable to identify a current stage of a sales cycle based on structured CRM data; (3) generating, based on the unstructured CRM data, a historical unstructured CRM dataset corresponding to the set of historical sales cycles, the historical unstructured CRM dataset including a set of documents that each include textual data corresponding to electronic communications between one or more clients and one or more providers associated with the set of historical sales cycles; (4) determining, for each document of the set of documents (a) a stage of a sales cycle associated with the document (e.g., where the stage of the sales cycle associated with a document is determined based on a supervised learning process that includes labeling of the document with the associated stage of the sales cycle); and (b) a numerical representation of the document (e.g., where the numerical representation of the document includes a vector determined by vectorization of the textual data of the document); (5) determining, based on the documents, a document-to-stage model configured to determine a stage of a sales cycle based on textual data of documents associated with the sales cycle (e.g., where the document-to-stage model includes one or more of: a document-to-vector model operable to determine vectors based on textual data of one or more documents; and a vector-to-stage model operable to determine a stage based on vectors including numerical representations of documents); (6) determining, for each document, a sentiment of the document; (7) determining, based on the numerical representations of the documents, document clusters; (8) determining, for each document cluster of the document clusters, a cluster word set (e.g., a word cloud) for the document cluster; (9) determining, for each document cluster of the document clusters based on the cluster word set for the document cluster, cluster attributes (e.g., where the cluster attributes for a document cluster include significant words of the cluster word set for the document cluster); (10) determining, based on some or all of (a) the one or more stage models, (b) the cluster attributes, and (c) the sentiments for the documents, a document model operable to determine current document attributes based on numerical representations of a set of current documents (e.g., where the numerical representations of the set of current documents include vectors representing the set of current documents); and (11) determining, based on (a) stage identification model (e.g., a stage attribute mapping) and (b) the sentiments for the documents, a stage prediction model operable to determine attributes of a current sales cycle based on (i) a current sales cycle stage and (ii) current document attributes. In some embodiments, a sales management process includes a sales cycle modeling process that includes the following: (1) obtaining a current CRM sales cycle dataset that includes: (a) current sales cycle structured data indicative of attributes of a current stage of a current sales cycles; and (b) current sales cycle unstructured data that includes current documents including textual data corresponding to current electronic communications between one or more clients and one or more providers of the current sales cycle; (2) determining, based on application of the current sales cycle structured data to the stage identification model, a current stage of the current sales cycle; (3) determining, based on the current sales cycle unstructured data, a current set of numerical representations of the current set of documents (e.g., where the numerical representations of the current set of documents include vectors determined by way of vectorization of the textual data of the current set of documents); (4) determining, based on application of the set of the current set of numerical representations of the current set of documents to the document model, a current set of attributes for the current sales cycle; and (5) determining, based on application of (a) the current stage of the current sales cycle and (b) the current set of attributes for the current sales cycle to the stage prediction model, a predicted outcome for the current sales cycle (e.g., where the predicted outcome is indicative of a stage or other portion of a sales cycle that the current sales cycle is predicted to reach). In some embodiments, a sales cycle modeling process includes determining a CRM plan to generate an improved outcome, which may, for example, be provided along with the predicted outcome. In certain embodiments, the CRM plan defines a sales cycle action to be taken, and the sales management process includes executing, based on the CRM plan, the sales cycle action.

Although certain embodiments are described in the context of a given sales environment, such as software sales, and including a given set of stages and source data, embodiments may be employed in any suitable context, such as with various cycles, products, stages, and source data. For example, although certain embodiments are described in the context of sales cycles, such as the monitoring and management of progression a “deal” through a sales process from initiation to completion, for the purpose of explanation, embodiments may be employed in any suitable context, such as with various products, stages, and source data. For instance, embodiments may include modeling, and implementation of models, for various portions and stages of a product design cycle, such as product conception, product design, product testing, product sale and implementation, and the like, where the models are trained based on historical product design data sourced from prior product design cycles.

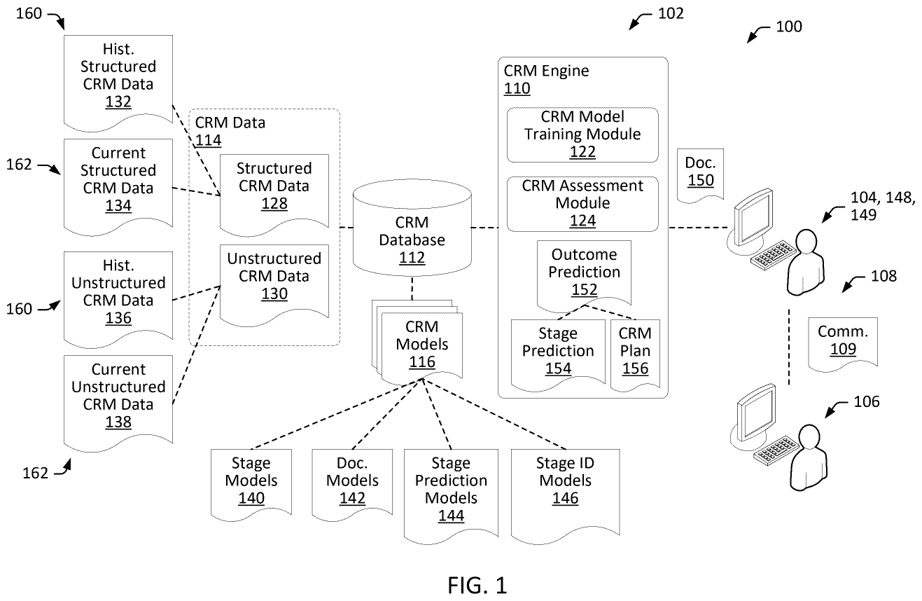

FIG. 1 is a diagram that illustrates a sales cycle environment (“environment”) 100 in accordance with one or more embodiments. In the illustrated embodiment, environment 100 includes a sales management system (“management system”) 102, a provider entity (“provider”) 104, a customer entity (“customer”) 106, and a sales environment 108 that, for example, facilitates exchange of communications 109 and items (e.g., good or services) between provider 104 and customer 106. Management system 102 includes a customer relationship management (CRM) engine 110 and a CRM database 112 storing CRM data 114 and CRM models 116. CRM engine 110 includes a CRM model training module (“training module”) 122 and CRM assessment module 124. CRM data 114 includes structured CRM data 128 and unstructured CRM data 130. Structured CRM data 128 including historical structured CRM data 132 and current structured CRM data 134. Unstructured CRM data 130 including historical unstructured CRM data 136 and current unstructured CRM data 138. CRM models 116 including one or more of document models 142, stage prediction models 144, and stage identification models 146. As described, documents 150, such e-mails or other datasets representative communications 109, may be processed by management system 102 to generate CRM models 116 for associated cycles or be applied to one or more of CRM models 116 to determine cycle outcome predictions (or “outcome predictions”) 152, which may, for example, include a stage prediction 154 that is indicative of a stage that an associated sales cycle is predicted to reach and a CRM plan 156 that includes or more recommended actions (e.g., “next best actions”) to generate an improved outcome. Structured CRM data 128 may be received from a structured CRM data source 148, such as provider 104 or another entity of sales environment 108. Unstructured CRM data 130 may be received from an unstructured CRM data source 149, such as provider 104 or another entity of sales environment 108.

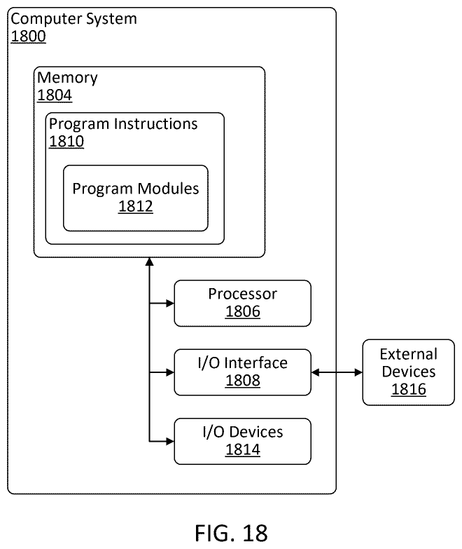

In some embodiments, management system 102 includes one or more entities that are operable to determine outcome predictions 152 based on assessment of associated CRM data 114, which may, for example, be obtained at least in part from documents 150 representing communications 109 associated with a sales cycle. In some embodiments, management system 102 includes a computer system that is the same or similar to that of computer system 1800 described with regard to at least FIG. 18. In some embodiments, management system 102 is operable to generate one or more CRM models 116 based on historical CRM data 160, e.g., including historical structured CRM data 132 (e.g., observed attribute-value pairs for sales cycle attributes of sales cycles) and historical unstructured CRM data 136 (e.g., text or other unstructured data of e-mail or similar type documents 150 concerning communications 109 between parties to sales cycles), and apply current CRM data 162, including current structured CRM data 134 (e.g., observed attribute-value pairs for sales cycle attributes for a sales cycle over a recent interval of time) and current unstructured CRM data 138 (e.g., text or other unstructured data of e-mail or similar type documents 150 concerning recent communications 109 between parties to the sales cycle over the recent interval of time) to one or more CRM models 116 to generate outcome predictions 152. This may include, for example, training module 122 being operable to train a document model 142, a stage prediction model 144, a stage identification model 146 for each of one or more stages of a sales cycle (e.g., for each of some or all of initial contact, document sharing, letter of intent, proposal, negotiations, on-hold/lost/won, or the like stages) based on historical CRM data 160, including historical structured and unstructured CRM data 132 and 136, and CRM assessment module 124 operable to apply current CRM data 162, including current structured CRM data 134 (e.g., observed attribute-value pairs for sales cycle attributes for a sales cycle over a recent interval of time) to a trained stage identification model 146 to determine a current stage of the sales cycle, and apply current unstructured CRM data 138 (e.g., text of e-mail type documents 150 concerning recent communications 109 between parties to the sales cycle over the recent interval of time) to a trained document model 142 to generate a set of document attributes for the stage (e.g., document clusters, sentiments, or the like), and apply the current stage and the set document attributes for the stage to a trained stage prediction model 144 for the stage, to determine an outcome prediction 152 for the sales cycle.

As an example, observed attribute-value pairs for sales cycle attributes of sales cycles over the course of a ten year period (e.g., including attribute-value pairs for customer identifier, salesperson identifier, product identifier, stages reached/completed, estimated value of the opportunity, anticipated close date, number of communications or interactions in each stage, last type/date of activity, or the like, and associated stage of the sales cycle for each) may be obtained and stored in historical structured CRM data 132 of CRM database 112 and be used (e.g., by training module 122) to train a stage identification model 146 that is operable to determine a current stage of a sales cycle based on current sales cycle attributes. Further, observed documents 150 (e.g., e-mails or other textual records of communications 109, or the like) for the same ten year period may be obtained and stored in historical unstructured CRM data 136 of CRM database 112 and be used (e.g., by training module 122) to train a document model 146 that is operable to determine current document attributes of a current set of documents. Moreover, a stage prediction model 144 may be trained based on the stage identification model 146 (e.g., including a mapping of sales cycle attributes to sales cycle stages) and sentiments determined from the observed documents 150 (e.g., from the e-mails or other textual records of communications 109, or the like) for the same ten year period, to be operable to determine an outcome prediction 152 for a sale cycle based on current CRM data 162, including current structured and unstructured CRM data 134 and 138, for the sales cycle.

In such an embodiment, observed attribute values for a sales cycle for a recent period, such as a most recent one-month period (e.g., including attributes values for customer identifier, salesperson identifier, product identifier, stages reached, estimated value of the opportunity, anticipated close date, number of communications or interactions in each stage, last type/date of activity, or the like, and associated stage of the sales cycle for each) may be obtained and stored in current structured CRM data 134 of CRM database 112 (e.g., as attribute value-pairs) and be applied (e.g., by assessment module 124) to the trained stage identification model 146 to determine a current stage of an associated sales cycle. Further, recently observed documents 150 (e.g., e-mails or other textual records of communications 109, or the like) for the same most recent one-month period may be obtained and stored in current unstructured CRM data 138 of CRM database 112 and be applied (e.g., by assessment module 124) to the trained document model 146 to determine document attributes (e.g., document clusters, sentiments, or the like) of the current stage of an associated sales cycle. The determined current stage and the determined document attributes may be applied (e.g., by assessment module 124) to the trained stage prediction model 144 to determine an outcome prediction 152 for the sale cycle, which may, for example, include a stage prediction 154 that is indicative of a stage that the associated sales cycle is predicted to reach or a CRM plan 156 that outlines or more recommended actions to generate an improved outcome for the associated sale cycle. A sales cycle action may, for example, be executed (e.g., in sales environment 108 by provider 104 or another entity) based on an outcome prediction 152. If, for example, a sales cycle outcome prediction 152 indicates that a sales cycle is currently in the letter of intent (LOI) stage, includes a stage prediction 154 indicating that the sales cycle is predicted to stall/fail in the negotiations stage, and includes a CRM plan 156 that recommends contacting the client by phone to discuss modifying the letter of intent to preemptively address a range of sales price to be negotiated, provider 104 may, in response to the outcome prediction 152, call customer 106 by phone to discuss modifying the LOI to preemptively set a range of the ultimate sales price to be negotiated, which may, in turn, help facilitate completion of the negotiations stage.

In some embodiments, a stage prediction model 144 is generated for one or more given stages. For example, a stage prediction model 144 that is generated for a LOI stage may be operable to determine an outcome prediction based on attributes (e.g., sentiments, etc.) of documents associated with the LOI stage. In such an embodiment, in response to determining a given stage (e.g., described here at block 292 and 294), the stage prediction model 144 for that stage may be employed, with the sentiments of documents associated with the stage being applied to the associated stage prediction model 144 to determine an outcome prediction 152. For example, where a stage identification of LOI is identified for a set of documents 150, attributes (e.g., sentiments, etc.) determined for the documents 150 may be applied to a “LOI” stage prediction model 144 to determine an outcome prediction 152 therefore.

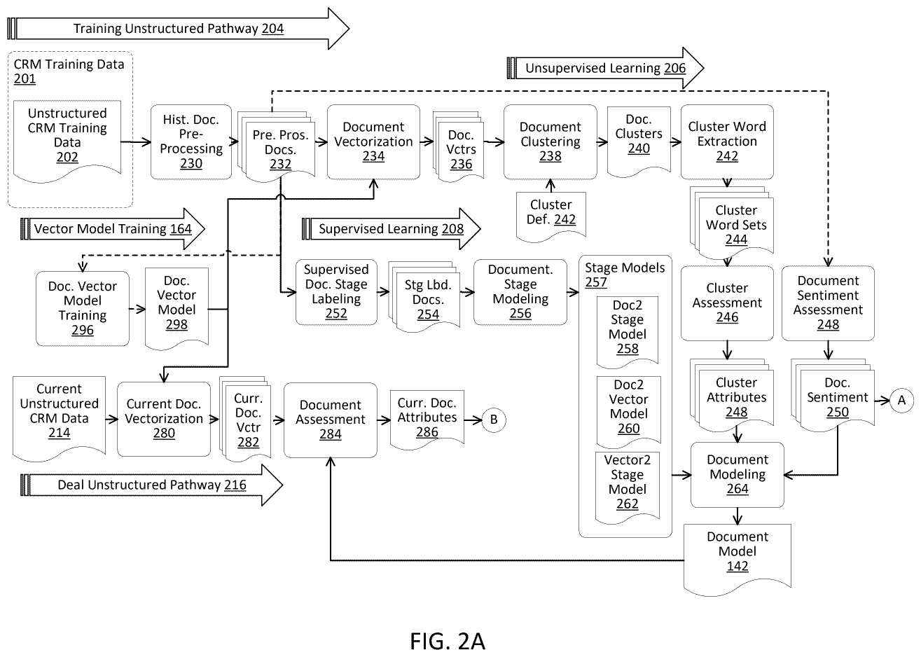

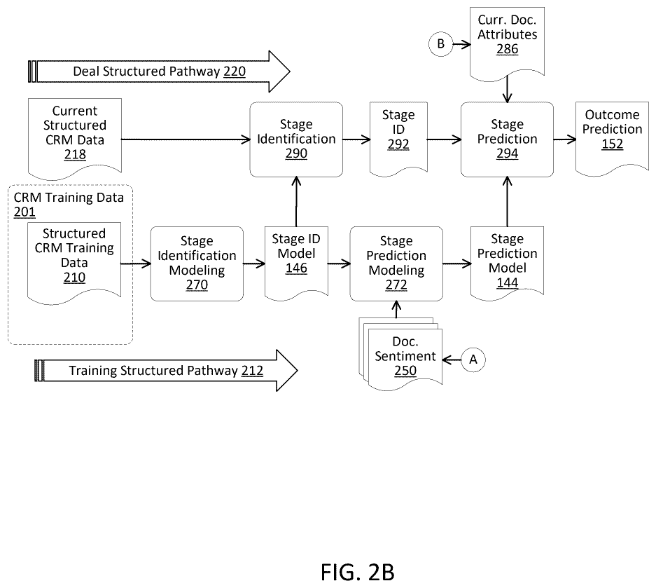

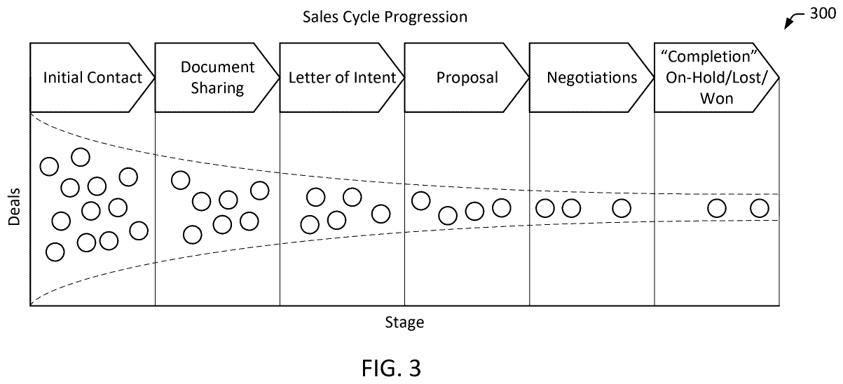

As described here, FIGS. 2A and 2B provide a flow diagram that illustrates operational aspects of a sales management system, such as management system 102, in accordance with one or more embodiments. FIG. 3 is a diagram that illustrates a sales cycle progression 300 in accordance with one or more embodiments. The sales cycle progression 300 includes a series of discrete stages that includes an initial contact stage (e.g., where an initial inquiry happens regarding the product/service to be bought/sold), a document sharing stage (e.g., where the documentation about the product or service is being shared between the two parties), a letter of intent (LOI) stage, (e.g., where an authorized email/letter from the respective in charge will be issued towards further exploration of the product/service), a proposal stage (e.g., where a proposal along with the terms and conditions as well as financials will be shared between the parties), a negotiations stage (e.g., where negotiations take place between the parties on all critical aspects of the product/service), and a on-hold/lost/won (or “completion”) stage (e.g., a final stage of the proposal where the product/service is or is not provided and supported). The two dashed line represents a “funnel” that is indicative of the percentage of deals (represented by circles) that progress through the stages, with the narrowing representing a decreasing number of deals progressing into the later stages. One focus of the embodiments described is to increase the area between the two dashed lines later in the cycle by helping sales deals to continue and mature along the sales cycle, to a successful completion stage.

In some embodiments, structured CRM data 128 is data that is organized and formatted in a specific and predefined manner, for example, making it readily searchable, analyzable, and understandable by machines. Structured CRM data 128 may have a defined format, such as being organized into a tabular format, where each data point is stored in a separate field or column, and rows represent individual records or observations. Structured CRM data 128 may have consistency and uniformity, with clearly defined data types, relationships, and constraints. In some embodiments, structured CRM data 128 is organized into a well-defined format, such as a table, spreadsheet, or database schema, with, for example, each piece of data is stored in a field with a specific data type (e.g., text, number, date) and follows a consistent structure across all records. Structured CRM data 128 may be associated with a schema that defines the structure, constraints, and relationships within the data, with, for example, the schema specifying the names and data types of each field, as well as any rules or constraints that govern the data's organization and integrity. Structured CRM data 128 may be highly queryable, meaning that it can be easily searched, filtered, and sorted using database query languages (e.g., SQL), which, for example, may allow users to retrieve specific subsets of data based on criteria such as value matching, range queries, or logical conditions. Structured CRM data 128 may be relational, having relationships between different entities or tables within a database, where, for example, these relationships are defined by keys or identifiers that link related records together, enabling complex queries and analyses across multiple tables. Structured CRM data 128 may be scalable, being able to scale to handle large volumes of information efficiently, such as with modern database management systems (DBMS) that are designed to manage terabytes or even petabytes of structured data while providing fast query performance and data integrity. Structured CRM data 128 may be interoperable, lending itself well to interoperability with other systems and applications, with, for example, use of standardized formats and protocols (e.g., CSV, JSON, XML) that facilitate the exchange of structured data between different platforms and tools, enabling seamless integration and data sharing. In some embodiments, structured CRM data 128 includes observed attribute-value pairs for sales cycle attributes of sales cycles. For example, structured CRM data 128 for a given sales cycle may include attribute-value pairs for customer identifier, salesperson identifier, product identifier, current stage, stages reached/completed, estimated value of the opportunity, anticipated close date, number of communications or interactions in each stage, last type/date of activity, or the like, and an associated stage of the sales cycle for each, arranged in a structured format, such as a column/row format. This may include, for example, attribute-value pairs arranged in a column/row format, with a first column being a customer identifier attribute, a second column being a salesperson identifier attribute, and with each row representing a set of values for a given sales cycle, such that the first column in the row is a given customer identifier for the customer identifier attribute and the second column of the same row is a given salesperson identifier for the salesperson identifier attribute, and so forth.

In some embodiments, historical CRM data 160 includes data associated with a historical time interval of interest, such as the last ten years. In some embodiments, current CRM data 162 includes data associated with a recent time interval of interest (e.g., a significantly shorter interval than the historical time interval of interest, e.g., less than 25%, 10%, 5%, 1%, 0.5% or the like thereof), such as a last day or most recent set of several days. In some embodiments, historical CRM data 160 is a subset of CRM data 114 that does not overlap with current CRM data 162. For example, historical CRM data 160 may include CRM data 114 for a 14 year period, from May 1, 2010 to Apr. 30, 2024, and current CRM data 162 may include CRM data 114 for a given interval (e.g., for a one week period from May 1, 2024 to May 8, 2024), over the life of the associated sales cycle (e.g., for a six week period from the start of the sales cycle on May 1, 2024 to Jun. 12, 2024), or the like. As described, historical CRM data 160 may be used to generate CRM models 116 and current CRM data 162 may be applied to models to determine items of interest, such as sales cycle (or “deal”) outcome predictions. In some embodiments, historical CRM data 160 includes historical structured CRM data 132 and historical unstructured CRM data 136. In some embodiments, current CRM data 162 includes current structured CRM data 134 and current unstructured CRM data 138. In some embodiments, CRM data 114 may be obtained by way of monitoring of communications (e.g., between providers 104 and customers 106) and other information by way of a CRM management module operating on CRM engine 110, or the like. For example, a CRM management module of CRM engine 110 may intercept all communications between provider 104 and customer 106 and store them as CRM data 114 on CRM database 112.

In some embodiments, historical structured CRM data 132 includes values of attributes for one or more stages of a sales cycle over a historical time interval. For example, a subset of structured CRM data 128 may be historical structured CRM data 132 that includes an observed customer identifier associated with each stage of each sales cycle over the last 14 years. In some embodiments, current structured CRM data 134 includes values of attributes for one or more stages of a sales cycle for a recent point in time or time interval. For example, a subset of structured CRM data 128 may be current structured CRM data 134 that includes a recently observed customer identifier and so forth, associated with each stage of a current sales cycle being assessed.

In some embodiments, unstructured CRM data 130 is data that lacks a predefined data model or organizational structure. Unlike structured data (e.g., organized into rows and columns with a clear schema), unstructured data may not conform to any specific format or organization. Instead, it may exist in a variety of formats and contain a wide range of content, including text, images, audio, video, or the like. Unstructured CRM data 130 may not adhere to a predefined schema or structure. For example, unstructured CRM data 130 may be stored in files, documents, or multimedia files without any consistent formatting or organization. Unstructured CRM data 130 may have varied format, for example, taking one or more of many different forms, including plain text, PDF documents, emails, electronic text messages (e.g., SMS (Short Message Service) messages), social media posts, images, audio recordings, video files, and more, with different types of data having its own unique format and characteristics. Unstructured CRM data 130 may be semantically complex, for example, containing rich semantic content, such as natural language text, which may be highly nuanced, context-dependent, and ambiguous, which can, in turn, present challenges for understanding and analyzing unstructured data using traditional methods. Unstructured CRM data 130 may have a relatively large volume, for example, constituting a significant portion of the total data generated and stored by organizations, including text documents, email archives, social media feeds, and multimedia files, which can accumulate in large volumes over time. Unstructured CRM data 130 may exhibit limited query ability. Unlike structured data, which is relatively highly queryable using database query languages, unstructured data may be less amenable to direct querying and analysis. For example, extracting meaningful insights from unstructured data may benefit from advanced text processing, natural language processing (NLP), audio sound recognition, voice to text, computer vision, image recognition, or other techniques. Unstructured CRM data 130 may be a suitable subject for semantic analysis, including extracting and understanding the underlying semantics, context, and meaning of the content. This may include tasks such as sentiment analysis, entity recognition, topic modeling, and document classification. While unstructured CRM data 130 may require specialized tools and techniques for analysis, it may contain insights that can complement and enrich structured CRM data 128, by, for example, providing enhanced comprehension and understanding of complex real-world phenomena associated with the structured CRM data 128.

In some embodiments, unstructured CRM data 130 includes content published during a defined time interval. For example, unstructured CRM data 130 may include media content (e.g., text, images, audio, video, and multimedia presentations) published over the course of the same timeframe as the structured transaction data (e.g., over the last 10 years) that includes unstructured content. This may include, for example, communications 109 exchanged between provider 104 and customer 106, or other entities of sales environment 108. For example, unstructured CRM data 130 may include all, or a subset of, e-mails, text messages, chat messages, or the like type communications 109 exchanged between provider 104 and customer 106, or other entities of sales environment 108. In some embodiments, content of communications 109 may, for example, be recorded in one or more documents 150. For example, content of each e-mail exchanged between provider 104 and customer 106 (e.g., text of the e-mail) may be stored in a respective e-mail type document 150, content of each text message exchanged between provider 104 and customer 106 (e.g., text of the text message) may be stored in a respective text message type document 150, content of each chat conversation between provider 104 and customer 106 (e.g., text of the chat conversation) may be stored in a respective chat type document 150, or the like. A document may be a file or other collection of data including un-structured or structured data, in the form of text, images, sound, or the like.

In some embodiments, historical unstructured CRM data 136 includes content associated with one or more stages of a sales cycle over a historical time interval. For example, a subset of unstructured CRM data 130 may be e-mails exchanged between providers 104 and customers 106 over the past 14 years. In some embodiments, current unstructured CRM data 138 includes content associated with one or more stages of a sales cycle for a recent point in time or time interval. For example, a subset of unstructured CRM data 130 may be current unstructured CRM data 138 that includes e-mails exchanged between providers 104 and customers 106 during a time interval associated with a most recent stage, multiple recent stages, or any stages of a current sales cycle being assessed.

In some embodiments, provider 104 includes one or more entities that are interested in completing a sales cycle to provide items, such as goods or services, to customer 106. For example, provider 104 may include a company (e.g., a vendor) that produces and sells project management tool software. In some embodiments, provider 104 includes a computer system that is the same or similar to that of computer system 1800 described with regard to at least FIG. 18. In some embodiments, customer 106 includes one or more entities that are interested in completing a sales cycle to obtain items, such as goods or services, from provider 104. For example, customer 106 may include a company that desires to acquire project management software. In some embodiments, customer 106 includes a computer system that is the same or similar to that of computer system 1800 described with regard to at least FIG. 18.

In some embodiments, CRM environment 108 includes one or more entities, system or the like that are operable to facilitate communications 109, exchange of items, or the like. Continuing with the above example regarding sales cycle communications 109 that include e-mail type exchanges, CRM environment 108 may, for example, be an electronic communications network (e.g., the Internet), or the like. In some embodiments, CRM environment 108 includes a computer system that is the same or similar to that of computer system 1800 described with regard to at least FIG. 18.

FIGS. 2A and 2B depict a flow diagram 200 that illustrates operational aspects of sales management system 102 in accordance with one or more embodiments.

In the illustrated embodiment, unstructured CRM training data 202 (of CRM training data 201) is processed along an unstructured pathway 204 (that includes processing along an unsupervised learning pathway 206 and a supervised learning pathway 208) to generate a document model 142, and structured CRM training data 210 (of CRM training data 201) is processed along a structured pathway 212 to generate a stage identification model 146. Further, current unstructured CRM data 214 (e.g., of current CRM data 162) is processed along a current unstructured (or “deal unstructured”) pathway 216 to generate current document attributes (e.g., including document sentiment, document clusters, or the like), and current structured CRM data 218 (e.g., of current CRM data 162) is processed along a current structured (or “deal structured”) pathway 220 that includes processing to arrive at a stage identification. A stage prediction model 144 is generated based on the stage identification model 146 (e.g., determined from structured pathway 212) and corresponding historical document sentiments (e.g., determined from unsupervised learning pathway 206 of unstructured pathway 204), and current document attributes and a current stage identification are applied to the stage prediction model 144 to generate an outcome prediction 152. Structured CRM training data 210 may include some or all (e.g., be a subset of) historical structured CRM data 132. Unstructured CRM training data 202 may include some or all (e.g., be a subset of) historical unstructured CRM data 136. Current structured CRM data 218 may include some or all (e.g., be a subset of) current structured CRM data 134. Current unstructured CRM data 202 may include some or all (e.g., be a subset of) current unstructured CRM data 138.

Referring first to unstructured pathway 204, in some embodiments, historical document pre-processing 230 includes processing of unstructured CRM training data 202 for a time interval of interest to generate corresponding pre-processed documents 232. For example, where historical unstructured CRM data 136 includes 150,000 e-mail communications 109 between providers 104 and customers 106 of sales cycles for sales of project management software over a 14 year period, from May 1, 2010 to Apr. 30, 2024, and a document model 142 is to be generated on May 1, 2024 using a recent ten years of historical unstructured CRM data 136, unstructured CRM training data 202 may include a subset of historical unstructured CRM data 136 that includes 100,000 e-mail communications 109 from May 1, 2014 to Apr. 30, 2024, with each e-mail being represented by a respective e-mail document (e.g., an electronic document including the text of the body of the associated e-mail), and those 100,000 e-mails may be pre-processed (e.g., cleaned) to generate 100,000 corresponding pre-processed documents 232 (e.g., 100,000 corresponding cleaned documents). In some embodiments, content pre-processing 220 of a document of unstructured transaction data includes conducting a document cleaning operation that includes converting text of the document to lowercase to generate lower case text, removing any non-alphanumeric characters from the lowercase text to generate lower case and non-alphanumeric text, splitting sentences of the lower case and non-alphanumeric text into words to generate tokenized text, removing words less than a given number of characters (e.g., less than 3 characters) to generate tokenized character basis text, and rejoining words of the tokenized character basis text to generate a clean sentence form of the text of the document. Converting text to lowercase (e.g., converting all the text in the document to lowercase) may ensures that words are treated uniformly regardless of their original casing. Removing non-alphanumeric characters (e.g., removing any characters that are not letters or numbers from the lowercase text) may include removing punctuation marks, special symbols, and any other non-alphanumeric characters. Splitting sentences into words (e.g., splitting the text into individual words after removing non-alphanumeric characters), sometimes referred to as “tokenization,” may separate the text into meaningful units (words) based on spaces between them. Removing short words (e.g., removing words that are shorter than a specified number of characters e.g., less than 3 characters) from the tokenized text can help filter out very short and often irrelevant words like “a”, “an”, “the”, etc. Rejoining words (e.g., rejoining the remaining words to form clean sentences), may involve putting the words back together in the original order, separated by spaces, to reconstruct the text in a readable sentence form. Continuing with the prior example, by following some or all of these preprocessing steps, the document text of each of the 100,000 e-mails may be transformed into a respective set of pre-processed content (or “clean content”) that includes, for example, a respective cleaned document for each of the 100,000 e-mails, resulting in a set of 100,000 cleaned documents. Such pre-processed (or “cleaned”) document content may be cleaner and more standardized format, which can be further analyzed or used for natural language processing tasks like text classification, sentiment analysis, and more.

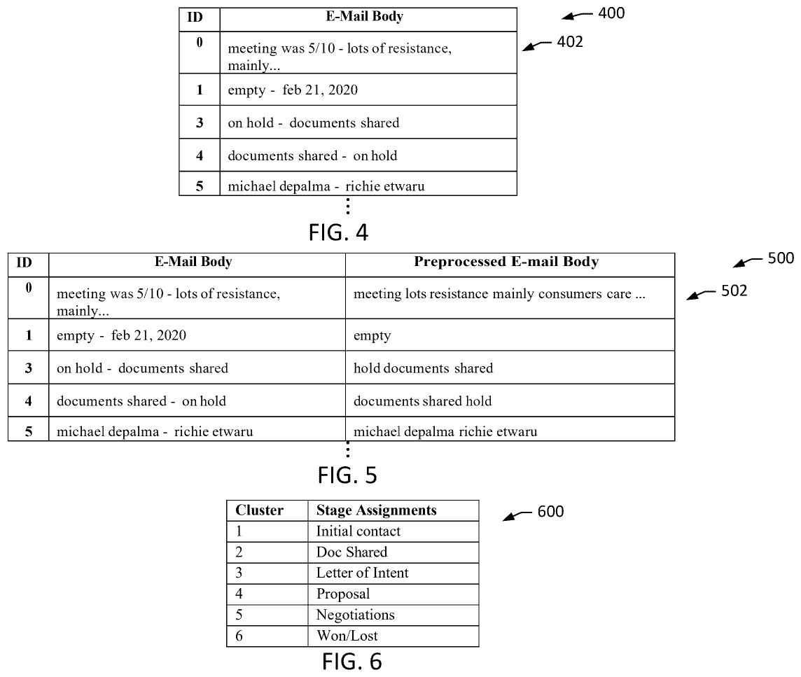

FIG. 4 is a diagram that illustrates document content in accordance with one or more embodiments. The illustrated embodiment includes a document table 400 that includes rows (or “entries”) 402 corresponding to respective e-mail documents, including a corresponding identifier and un-processed (or “dirty”) unstructured text of the e-mail body. Each entry of the tables may include or at least be representative of an e-mail type document. In some embodiments, such a table is present in unstructured CRM data 130. For example, historical unstructured CRM data 138 may include a similar table including entries for each of the 150,000 e-mail communications 109 over the 14 year period, from May 1, 2010 to Apr. 30, 2024. Further, unstructured CRM training data 202 may include a similar table including entries for each of the 100,000 e-mail communications 109 over the 10 year period, from May 1, 2014 to Apr. 30, 2024.

FIG. 5 is a diagram that illustrates pre-processed document content in accordance with one or more embodiments. The illustrated embodiment includes a processed document table 500 that includes rows (or “entries”) 502 corresponding to respective e-mail documents, with each row 502 including a corresponding identifier and corresponding pre-processed unstructured text of the e-mail body. Each entry of the tables may, for example, include or at least be representative of an un-structed document, such as e-mail type document. In some embodiments, pre-processed documents 232 are represented by such a table. For example, unstructured CRM training data 202 may include table 400 of FIG. 4, including un-processed entries for each of the 100,000 e-mail communications 109 over the 10 year period, from May 1, 2014 to Apr. 30, 2024, and pre-processed documents 232 may include table 500 of FIG. 5, including pre-processed (or “cleaned”) entries 502 for each of the 100,000 e-mail communications 109 over the 10 year period, from May 1, 2014 to Apr. 30, 2024.

In some embodiments, document vectorization 234 includes processing pre-processed content (such as cleaned documents) to generate corresponding document vectors 234 or similar numerical representations thereof. Continuing with the above example, document vectorization 234 may include conducting a vectorization of each of the 100,000 pre-processed documents 232 to generate a corresponding document vector 236 to generate a corresponding set of document vectors 236 for the 100,000 e-mails. In some embodiments, vectorization includes creating a vocabulary consisting of unique words for the set of pre-processed documents 232, and applying a vectorization technique (e.g., One-Hot Encoding, TF-IDF (Term Frequency-Inverse Document Frequency), Word2Vec, Doc2Vec, or Bag-of-Words (BoW)), to generate a corresponding vector representation for each pre-processed document 232. Vectorization using One-Hot Encoding may, for example, include each document represented as a binary vector where each element corresponds to the presence or absence of a word from the vocabulary in that document. For example, if the vocabulary consists of [“apple”, “banana”, “orange”], and a document contains the text “apple banana”, its one-hot encoded representation would be [1, 1, 0] because it has both “apple” and “banana”. Vectorization using TF-IDF (Term Frequency-Inverse Document Frequency) may include each document represented as a vector where each element corresponds to the TF-IDF score of a word from the vocabulary in that document. TF-IDF considers both the frequency of a term in a document and its rarity across all documents. For example, if the term “banana” appears frequently in a document but rarely in the entire corpus, it will have a high TF-IDF score for that document. Vectorization using Word2Vec may include representing each word in a high-dimensional vector space based on the context in which it appears. Documents are represented as the average or sum of the Word2 Vec embeddings of all the words in the document. For example, “apple” might be represented as [0.2, 0.3, −0.1, . . . ], and a document containing “apple banana” might be represented as the average of the two vectors. Vectorization using Doc2Vec may extends Word2Vec to represent entire documents in a continuous vector space. Each document is represented as a vector, similar to Word2Vec embeddings, capturing the semantic meaning of the document. Doc2Vec can take into account both the words in the document and the context in which they appear. A 100-dimensional vector in Word2Vec refers to the embedding vector generated for each word or document when using Word2Vec with a specified dimensionality of 100. In Word2Vec, each word in a given vocabulary is represented by a dense vector of real numbers (embedding), where the dimensionality of the vector is typically chosen based on the specific application and computational constraints. For example, if a Word2Vec model is trained with a 100-dimensional (or “100-d”) embedding space, each word in the vocabulary will be represented by a vector of length 100. These vectors capture the semantic meaning of the words in a continuous vector space, allowing for operations like word similarity calculations and vector arithmetic. Similarly, if using Doc2Vec and specifying a 100-d vector space, each document in the corpus will be represented by a 100-d vector capturing its semantic meaning in relation to other documents and words in the corpus. These vectors are learned during the training process of Word2Vec or Doc2Vec models and can be used in downstream natural language processing tasks for tasks like sentiment analysis, document classification, or information retrieval. Vectorization using Bag-of-Words (BoW), digital lexicon or Large Language Library (LLL) may include each document represented as a vector where each element corresponds to the count of a word from the vocabulary in that document. For example, if the vocabulary consists of [“apple”, “banana”, “orange”], and a document contains the text “apple banana banana”, its BoW representation would be [1, 2, 0] because it has 1 “apple”, 2 “banana”, and 0 “orange”. Continuing with the prior example, if a Word2Vec vectorization is employed, a 100-d Word2Vec model may be generated based on the 100,000 e-mails to generate a 100-d vector for each unique word in the corpus of pre-processed documents 232 for the 100,000 e-mails, and a 100-d vector for each corresponding pre-processed document 232 may be generated based on an average of the 100-d vector for each unique word in the pre-processed document 232. In some embodiments, the 100-d vectors for pre-processed documents 232 associated with e-mails in a given group (e.g., for a given day, for a given stage, to/from a given person, or the like) may be averaged to generate a 100-d vector representation for the group. Thus, for example, numeric representations may include a 100-d document vector 236 for each cleaned document 232. Or, for example, numeric representations may include, for each day of May 1, 2014 to Apr. 30, 2024, a single 100-d document vector 236 for the day, with the 100-d vector representing an average of the 100-d vectors for pre-processed documents 232 corresponding to the e-mails on that day. As described, in some embodiments, document vectors 236 of cleaned documents 232 may be employed in unsupervised learning pathway 206 to determine cluster attributes and documents sentiments for use in generating the document model 142 or the stage prediction model 144.

In some embodiments, document clustering 238 includes performing a clustering operation on document vectors 236 to determine document clusters 240. This may, for example, include determining a number of clusters corresponding to a predetermined cluster definition 242 (e.g., defining a number of clusters and respective tags therefore). For example, where a sales cycle includes six stages and it is desirable to generate document clusters for each stage, a user or other entity may provide a cluster definition 242 that identifies six distinct clusters to be generated, and a clustering operation is performed on the document vectors 236 to determine six document clusters 240, one for each stage of the sale cycle. The clustering operation may operate to place similar items in the same cluster and place dissimilar items in different clusters. In some embodiments, for each document, a corresponding document vector 236 is assessed to determine a probability of the document being grouped in each of the clusters, the cluster with the highest probability is selected, and the document vector 236 (or associated data, such as the corresponding document 232) is assigned to, or otherwise associated with, the selected cluster. This may involve minimizing an objective function and may be measured, for example using a calculated coefficient, such as a Fuzzy Partitioning Coefficient (FPC). The clustering operation may include Unsupervised Clustering, FCM Clustering, Cluster Profiling, Cluster Tagging, or the like. Unsupervised Clustering may be a method where the artificial intelligence (AI) system groups data points into clusters based on similarities without pre-labeled categories or guidance, allowing for the identification of inherent patterns or structures within the data. FCM Clustering (Fuzzy C-Means Clustering) may be an Al technique utilizing deep learning, neural nets and or liquid nets that assigns each data point to one or more clusters with varying degrees of membership, providing a more nuanced grouping compared to hard clustering methods. Cluster Profiling may be a process where the AI system characterizes and summarizes the properties or attributes of each identified cluster, providing insights into the defining features of the groupings. Cluster Tagging may be the practice of labeling or annotating the identified clusters with meaningful tags or descriptors (e.g., a stage assignment), facilitating easier interpretation and understanding of the different groupings by end-users.

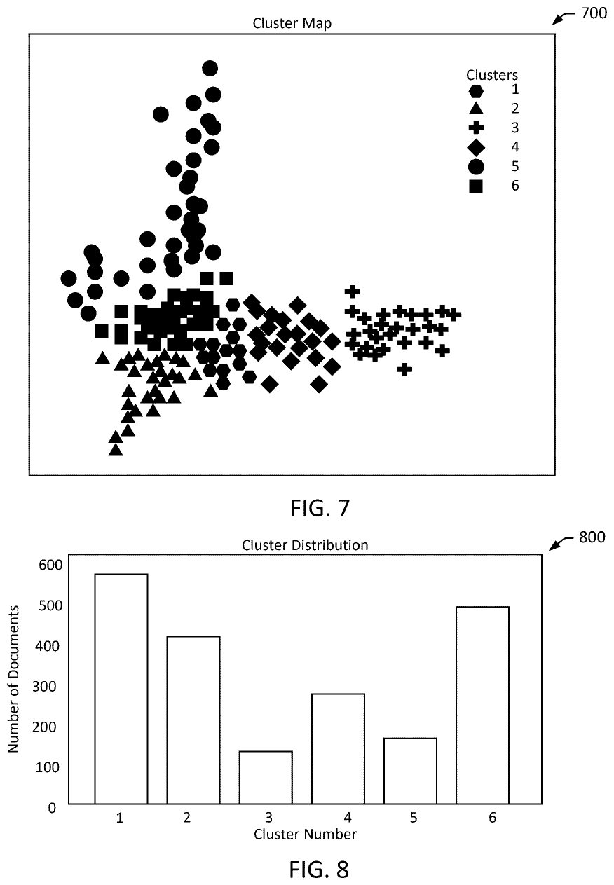

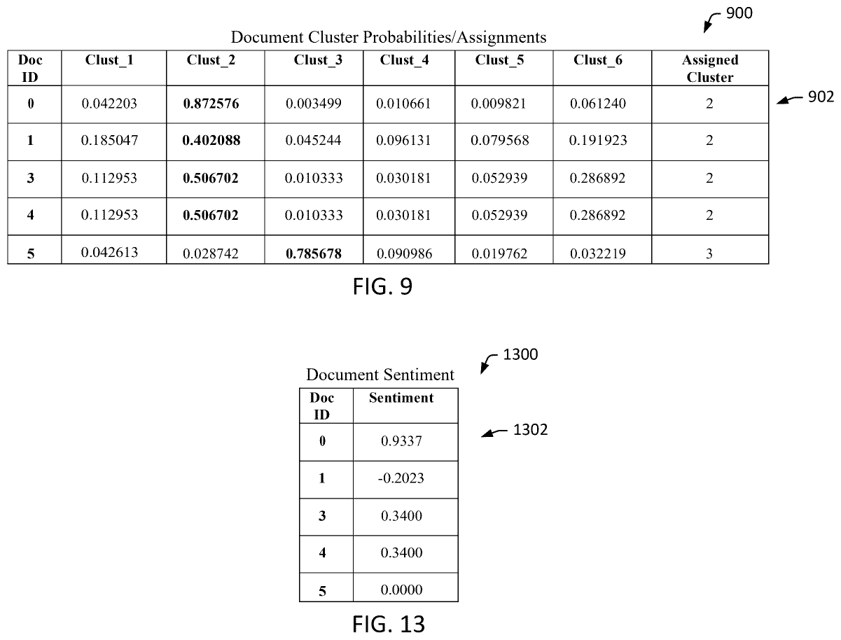

FIG. 6 is a diagram that illustrates a cluster definition 600 in accordance with one or more embodiments. For example, cluster definition 600 defines six clusters and, for each, a tag corresponding to a respective stage of a six part sales cycle. FIG. 7 is a diagram that illustrates a cluster map 700 in accordance with one or more embodiments. For example, cluster map 700 illustrates clustering of e-mail documents based on document vectors corresponding thereto, where each point corresponds to a document, and the shape of each point identifies which of the six clusters the e-mail document is associated with. FIG. 8 is a diagram that illustrates a cluster distribution 800 in accordance with one or more embodiments. For example, cluster distribution 800 may indicate a distribution of the documents of cluster map 700, including an indication of the number of documents associated with each of the six clusters. FIG. 9 is a diagram that illustrates document cluster probabilities and assignments in accordance with one or more embodiments. The illustrated embodiment includes a document cluster probabilities and assignments table 900 that includes rows (or “entries”) 902 corresponding to respective documents 232 and including a corresponding identifier, probabilities of the document corresponding to each of the six clusters, and an assignment indicting the document cluster that the e-mail document 232 is assigned to (e.g., corresponding to the cluster associated with the highest probability cluster for the document).

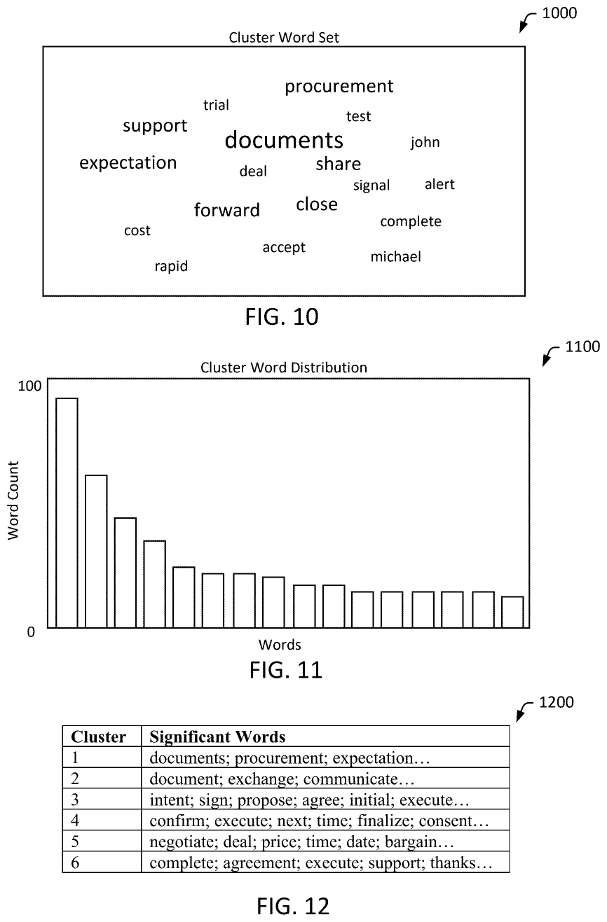

In some embodiments, cluster word extraction 242 includes for each document cluster 240, extracting most significant words from documents of the cluster 240, and generating a corresponding cluster word set 244 therefore. For example, where the 100,000 documents are each assigned to a given one of the six document clusters 240, cluster word extraction 242 may include for each of the six document clusters 240, extracting the most significant words from pre-processed documents 232 associated with the document clusters 240, and generating a word cloud type cluster word set 244 that includes the most significant words extracted. Cluster word extraction for a document cluster 240 may include any suitable word extraction technique, such as TF-IDF (Term Frequency-Inverse Document Frequency), Keyword Extraction Using TextRank, Topic Modeling Using Latent Dirichlet Allocation (LDA), Word Embeddings and Clustering, Custom Scoring with Domain-Specific Criteria, or the like. For example, cluster word extraction 242 may include TF-IDF type word extraction that employs a TF-IDF vectorizer to transform each pre-processed document 232 of the document cluster 240 into a matrix of TF-IDF features, with TF-IDF scores indicating the importance of a word in the document 232 relative to the entire set of documents 232 in the document cluster 240 and extracting words having the highest total TF-IDF scores. FIG. 10 is a diagram that illustrates a cluster word set 1000 in accordance with one or more embodiments. In the illustrated embodiment, cluster word set 1000 includes a word cloud, which may, for example, be a cluster word set 244 for a given one of the six document clusters 240. FIG. 11 is a diagram that illustrates a cluster word distribution 1100 in accordance with one or more embodiments. For example, cluster word distribution 1100 may indicate a distribution of the words in cluster word set 900, including an indication of the number of each word (or its synonym) present in cluster word set 900. FIG. 12 is a diagram that illustrates significant word sets of clusters 1200 in accordance with one or more embodiments. In the illustrated embodiment, each listing of significant words is associated with a respective one of the six clusters.

In some embodiments, cluster assessment 246 includes determining a corresponding set of cluster attributes 248 for document clusters 240. For example, where the 100,000 documents are each assigned to a given one of the six document clusters 240 and word extraction 242 includes determining, for each cluster of the six document clusters 240, a word set 244 that includes the most significant words or other attributes thereof, cluster assessment 246 may include determining cluster attributes 248 that include, for each cluster of the six document clusters 240, the word set 244 and the other attributes determined therefore.

In some embodiments, document sentiment assessment 248 includes determining a sentiment for clean documents 232. For example, where clean documents 232 include a cleaned version of each of the 100,000 e-mail documents, document sentiment assessment 248 may include determining a document sentiment for each of the 100,000 e-mail documents, where the document sentiments 250 include the sentiments for the 100,000 e-mail documents. Sentiment scores may be determined using any suitable technique, such as a NLTK Vader sentiment analyzer. that determines sentiment scores between +1 and −1 for each document, where −1 represent extreme negativity, 0 represents neutral sentiment, and +1 represents extreme positivity. FIG. 13 is a diagram that illustrates document sentiments in accordance with one or more embodiments. The illustrated embodiment includes a document sentiment table 1300 that includes rows (or “entries”) 1302 that correspond to respective documents 232, with each entry 1302 including a corresponding identifier and sentiment for the document 232. Such a set of sentiments may, for example, be appended to the document cluster probabilities and assignments table 900 of FIG. 9, to provide cluster assignment and sentiment scores for respective documents 232.

Referencing supervised learning pathway 208, in some embodiments, supervised document stage labeling 252 includes labeling clean documents 252 with a given stage to generate a set of stage labeled documents 254. For example, where pre-processed documents 232 include a cleaned version of each of the 100,000 e-mail documents, supervised document stage labeling 252 may include labeling (e.g., manually labeling) each of the 100,000 e-mail documents with a given one of the six stages of the sales cycle to generate a set of stage labeled documents 254 that include the set of 100,000 cleaned e-mail documents, and an associated stage label for each.

In some embodiments, document stage modeling 256 includes determining one or more stage models 257, such as a document-to-stage (“Doc2stage”) model 258 that is operable to determine a stage to be assigned to a document based on the document contents. For example, where the set of stage labeled documents 254 includes the 100,000 e-mail documents with an associated stage label, document stage modeling 256 may include a document-stage modeling operation that includes training, or otherwise generating, based on the set of stage labeled documents 254, a Doc2stage model 258 that is operable to determine a stage to be assigned to an e-mail document based on the textual content of the body, or the like, of the e-mail document.

In some embodiments, Doc2stage model 258 is a machine learning model. For example, Doc2stage model 258 may be a machine learning model employing one or more trained machine learning algorithms that are operable to determine a stage to be assigned to a document that are trained based on stage labeled documents 254 generated from unstructured CRM training data 202. In some embodiments, Doc2stage model 258 employs one or more of a given machine learning algorithm, such as Naive Bayes Classifier, Decision Trees, Support Vector Machines (SVM), K-Nearest Neighbors (KNN), Deep Learning Models, Neural Networks, Recurrent Neural Networks (RNNs), Long Short-Term Memory (LSTM), Gated Recurrent Unit (GRU), Convolutional Neural Networks (CNNs), Transformer Models, Ensemble Learning, Logistic Regression, Gradient Boosting, XGBoost, Unsupervised Clustering, FCM Clustering, Cluster Profiling, Cluster Tagging, Advanced Visualizations, Deep Learning, Neural Nets, Liquid Nets or the like. For example, Doc2stage model 258 may employ a Naive Bayes Classifier model trained using stage labeled documents 254 to determine a stage to be assigned to an e-mail document based on application of content of the e-mail document to the Doc2stage model 258. As described here, such a modeling process may include certain techniques, such as data pre-processing, data splitting, or the like to facilitate training of the Doc2stage model 258.

In some embodiments, document stage modeling 256 includes determining a document-to-vector (“Doc2vec”) model 260 or a vector-to-stage (“Vec2stage”) model 262. A Doc2vec model 260 may, for example, be operable to determine a representative vector of a document based on its contents. A Vec2stage model 262 may, for example, be operable to determine a stage associated with a document based on a corresponding representative vector of the document. For example, where the set of stage labeled documents 254 includes the 100,000 e-mail documents labeled, or otherwise associated with, a stage label identifying a corresponding one of the six stages of the sales cycle, document stage modeling 256 may include a document-to-vector modeling operation that includes generating, based on the contents of 100,000 e-mail documents, a Doc2vec model 260 that is operable to determine a representative vector for a document based on its contents, and a vector-to-stage modeling operation that includes determining, based on the vectors determined for the 100,000 e-mail documents, a Vec2stage model 262 that is operable to determine a stage for a document based on a representative vector for the document. Document-to-vector modeling may, for example, employ a vectorization technique that is the same or similar to that described above with regard to document vectorization 234. Vec2stage model 262 may include, for example, a mapping of each of the six stages to a respective signature vector. In some embodiments, a signature vector for a given stage may, for example, be an average of vectors determined for documents associated with the given stage. For example, where stage labeled documents 254 include 10,000 e-mail documents associated with the initial contact stage, document stage modeling 256 may include determining a vector for each of the 10,000 e-mail documents and averaging some or all of the 10,000 vectors to generate a signature vector for the initial contact stage. A similar process may be conducted for each of the other five stages to determine a respective signature vector for each of the six stages.

In some embodiments, document modeling 264 includes determining a document model 142 that is operable to determine one or more attributes of a document based on a vector representation of the document, or the like. For example, document modeling 264 may include training, or otherwise generating, based on Doc2Stage Model 258 (e.g., including Doc2Vector model 260 and Vector2Stage Model 262), cluster attributes 248 and document sentiments 250, a document model that is operable to determine one or more attributes of a document based on a document vector determined based on the contents of the document.

In some embodiments, document model 142 is a machine learning model. For example, Document model 142 may be a machine learning model employing one or more trained machine learning algorithms that are operable to determine one or more attributes of a document based on a representative vector for the document, or the like, that are trained based on based on Doc2Stage Model 258 (e.g., including Doc2Vector model 260 and Vector2Stage Model 262 trained based on supervised learning 208 based on unstructured CRM training data 202), cluster attributes 248 and document sentiments 250 (e.g., determined based on unsupervised learning 206 based on unstructured CRM training data 202). In some embodiments, document model 142 employs one or more of a given machine learning algorithm, such as Naive Bayes Classifier, Decision Trees, Support Vector Machines (SVM), K-Nearest Neighbors (KNN), Deep Learning Models, Neural Networks, Recurrent Neural Networks (RNNs), Long Short-Term Memory (LSTM), Gated Recurrent Unit (GRU), Convolutional Neural Networks (CNNs), Transformer Models, Ensemble Learning, Logistic Regression, Gradient Boosting, XGBoost, Unsupervised Clustering, FCM Clustering, Cluster Profiling, Cluster Tagging, Advanced Visualizations, Deep Learning, Neural Nets, Liquid Nets, or the like. For example, document model 142 may employ a Naive Bayes Classifier model trained using Doc2Stage Model 258 (e.g., including Doc2Vector model 260 and Vector2Stage Model 262), cluster attributes 248 and document sentiments 250 for pre-processed documents 232 of a set of unstructured CRM training data 202, to determine one or more attributes of a document based on a representative vector for the document. As described here, such a modeling process may include certain techniques, such as data pre-processing, data splitting, or the like to facilitate training of a document model 142. As described here, in some embodiments, current unstructured CRM data 214 (e.g., a set of one or more recent e-mail documents or vectors derived therefrom) are applied to document model 142 to generate document attributes that are, in turn, employed in a stage prediction operation to generate an outcome prediction 152.

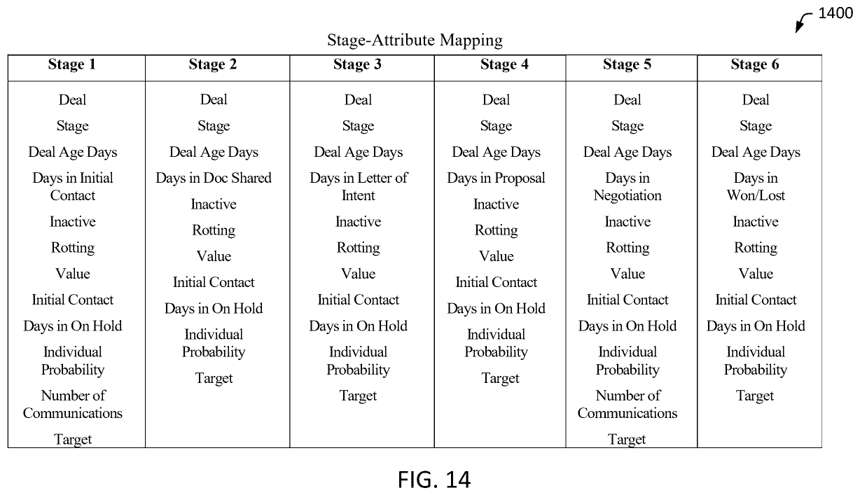

Referring to structured pathway 212, in some embodiments, stage identification modeling 270 includes processing of structured CRM training data 210 for a time interval of interest to generate a corresponding stage identification (ID) model 146 that is operable to determine a current stage of a sales cycle based on current structured CRM data for the sales cycle. For example, where historical structured CRM data 128 includes attribute-value pairs for of sales cycles for sales of project management software over the 14 year period, from May 1, 2010 to Apr. 30, 2024, and a stage ID model 146 is to be generated on May 1, 2024 using a most recent ten years of historical structured CRM data 128, structured CRM training data 210 may include a subset of historical structured CRM data 128 that includes 100,000 attribute-value pairs for of sales cycles from May 1, 2014 to Apr. 30, 2024, and stage modeling 270 may include training, based on the 100,000 attribute-value pairs, a stage ID model 146 that is operable to determine a current stage of a sales cycle based on current structured CRM data for the sales cycle. In some embodiments, a stage identification model 146 includes a stage-attribute mapping that maps stages to relevant attributes for determine a current stage of a sales cycle based on current structured CRM data for the sales cycle. FIG. 14 is a diagram that illustrates a stage-attribute mapping 1400 in accordance with one or more embodiments. In the illustrated embodiment, a set of attributes is mapped to each of the six stages.

In some embodiments, stage ID model 146 is a machine learning model. For example, stage ID model 146 may be a machine learning model employing one or more trained machine learning algorithms that are operable to determine a current stage of a sales cycle based on current structured CRM data for the sales cycle, or the like, that are trained based on based on historical structured CRM data 128 (e.g., structured CRM training data 210). In some embodiments, stage ID model 146 employs one or more of a given machine learning algorithm, such as Naive Bayes Classifier, Decision Trees, Support Vector Machines (SVM), K-Nearest Neighbors (KNN), Deep Learning Models, Neural Networks, Recurrent Neural Networks (RNNs), Long Short-Term Memory (LSTM), Gated Recurrent Unit (GRU), Convolutional Neural Networks (CNNs), Transformer Models, Ensemble Learning, Logistic Regression, Gradient Boosting, XGBoost, Unsupervised Clustering, FCM Clustering, Cluster Profiling, Cluster Tagging, Advanced Visualizations, Deep Learning, Neural Nets, Liquid Nets, or the like. For example, stage ID model 146 may employ a Naive Bayes Classifier model trained using historical structured CRM data 128 (e.g., structured CRM training data 210), to determine a current stage of a sales cycle based on current structured CRM data for the sales cycle. As described here, such a modeling process may include certain techniques, such as data pre-processing, data splitting, or the like to facilitate training of stage ID model 146. As described here, in some embodiments, current structured CRM training data 218 (e.g., a set of 1,000 attribute-value pairs) are applied to stage ID model 146 to identify a current stage of a sales cycle that is, in turn, employed in a stage identification operation to identify a current stage of a sales cycle.

In some embodiments, stage prediction modeling 272 includes processing of a stage ID model 146 generated based on structured CRM training data 210 for a time interval of interest and document sentiments 250 determined for the time interval of interest to generate a corresponding stage prediction model 144 that is operable to generate an outcome prediction 152 that includes, for example, a stage prediction 154 that indicates a stage to which a sales cycle will advance based on application of a current stage identification and document attributes for a corresponding current set of documents, such as recent text of communications (e.g., e-mail communications or the like) captured during a current stage, or one or more recent stages, of the sales cycle. For example, where a current stage associated with a given time period (e.g., the preceding week) is identified using a stage identification model 146 and a current set of document attributes for the same time period are identified using a document model 142, the current stage identification and the current set of document attributes may be applied to the to the trained stage prediction model 144 generate an outcome prediction 152 that includes, for example, a stage prediction 154 that indicates a stage that the sales cycle is expected to reach, such as initial contact, document sharing, letter of intent, proposal, negotiations, on-hold/lost/won, or the like. In some embodiments, an outcome prediction 152 includes or is otherwise accompanied by a CRM plan 156 that is expected to generate an improved outcome. For example, where an outcome prediction 152 determines that the sales cycle will reach a given stage that is short of a win, the outcome prediction 152 may indicate a given stage that the sales cycle is predicted to reach (e.g., negotiations) and a CRM 156 plan that defines one or more recommended “next best actions” to be taken to enhance the likelihood of the sales cycle advancing past the given stage, to a win scenario (e.g., “Action =Contacting the client by phone to discuss modifying the letter of intent to preemptively address a range of sales price to be negotiated”). As described, in some embodiments, a CRM plan 156 is executed in an effort to generate an improved cycle outcome.

Referring to current unstructured (or “deal unstructured”) pathway 216, in some embodiments, current document vectorization 280 includes pre-processing of current unstructured CRM data 214 for a time interval of interest to generate corresponding pre-processed current content (e.g., cleaned current documents), and processing the pre-processed current content to generate corresponding current document vectors 282 or similar numerical representations thereof. For example, where current unstructured CRM data 214 includes 1,000 e-mail communications 109 between providers 104 and customers 106 of a current sales cycle for a sale of project management software, from Jun. 10, 2024 to Jun. 16, 2024, with each e-mail being represented by a respective e-mail document (e.g., an electronic document including the text of the body of the associated e-mail), those 1,000 e-mails may be pre-processed (e.g., cleaned) to generate 1,000 corresponding pre-processed current documents (e.g., 1,000 corresponding cleaned documents). Continuing with this example, current document vectorization 280 may include conducting a vectorization of each of the 1,000 pre-processed current documents to generate a corresponding document vector 282 to generate a corresponding set of document vectors 282 for the 1,000 e-mails. In some embodiments, the pre-processing is the same or similar to that described with regard to historical document pre-processing 230. In some embodiments, the vectorization is the same or similar to that described with regard to historical document vectorization 234. In some embodiments, a document vector model training 296 is conducted based on pre-processed documents 232 to generate a corresponding document vector model 298, which may be employed in document vectorization processes, such as those described at blocks 234 and 280. Such a document vector model 298 may, for example, be a word-to-vector (“word2vec”) model.

In some embodiments, current document assessment 284 includes application of current document vectors 282 for a set of documents of current unstructured CRM data 214 for a given timer period to a document model 142 to determine a corresponding set of current document attributes 286 for the current unstructured CRM data 214. Continuing with the above example, current document assessment 284 may include application of current document vectors 282 for the 1,000 e-mail communications to determine a corresponding set of current document attributes 286 for the current unstructured CRM data 214 and the associated period of Jun. 10, 2024 to Jun. 16, 2024. The attributes may, for example, identify one or more clusters that the documents are associated with, a stage corresponding to each of the one or more clusters, sentiments scores for some or all of the e-mail documents, or the like.

Referring to current structured (or “deal structured”) pathway 220, in some embodiments, stage identification 290 includes application of current structured CRM data 218 for a given time period to a stage identification model 146 to determine a corresponding stage identification 292 for the time period associated with the current structured CRM data 218. Continuing with the above example, stage identification 290 may include application of current structured CRM data 218 associated with the time period of Jun. 10, 2024 to Jun. 16, 2024 (e.g., the same timeframe associated with the 1,000 e-mail communications) to determine one or more stages of the sales cycle (e.g., letter of intent (LOI) stage) that are associated with the time period.

In some embodiments, stage prediction 294 includes application of current stage identification 292 and current document attributes 286 for a given time period to a stage prediction model 144 to determine a corresponding outcome prediction 152. Continuing with the above example, stage prediction 294 may include application of a current stage identification of “letter of intent” (e.g., determined based on the structured CRM data 218 associated with the time period of Jun. 10, 2024 to Jun. 16, 2024) and current document attributes 286 (e.g., determined for the 1000 e-mails associated with the time period of Jun. 10, 2024 to Jun. 16, 2024) to determine an outcome prediction 152 that indicates a given stage that the sales cycle is predicted to reach (e.g., a “negotiations” stage) and a CRM 156 plan that defines one or more recommended “next best actions” to be taken to enhance the likelihood of the sales cycle advancing past the given stage and to a win scenario (e.g., “Action =Contacting the client by phone to discuss modifying the letter of intent to preemptively address a range of sales price to be negotiated”). As described, in some embodiments, a CRM plan 156 is executed in an effort to generate an improved outcome of the sales cycle.

As described, in some embodiments, an outcome prediction 152 includes a stage prediction 154 or a CRM plan 156 that is expected to generate an improved outcome. For example, where an outcome prediction 152 determines that the sales cycle will reach a given stage that is short of a win, the outcome prediction 152 may indicate a given stage that the sales cycle is predicted to reach (e.g., negotiations) and a CRM 156 plan that defines one or more recommended “next best actions” to be taken to enhance the likelihood of the sales cycle advancing past the given stage, to a win scenario (e.g., “Action =Contacting the client by phone to discuss modifying the letter of intent to preemptively address a range of sales price to be negotiated”). As described, in some embodiments, a CRM plan 156 is executed in an effort to generate an improved outcome. For example, provider 104 may, in response to the outcome prediction 152, call customer 106 by phone to discuss modifying the LOI to preemptively set a range of the ultimate sales price to be negotiated, which may, in turn, help facilitate completion of the negotiations stage.

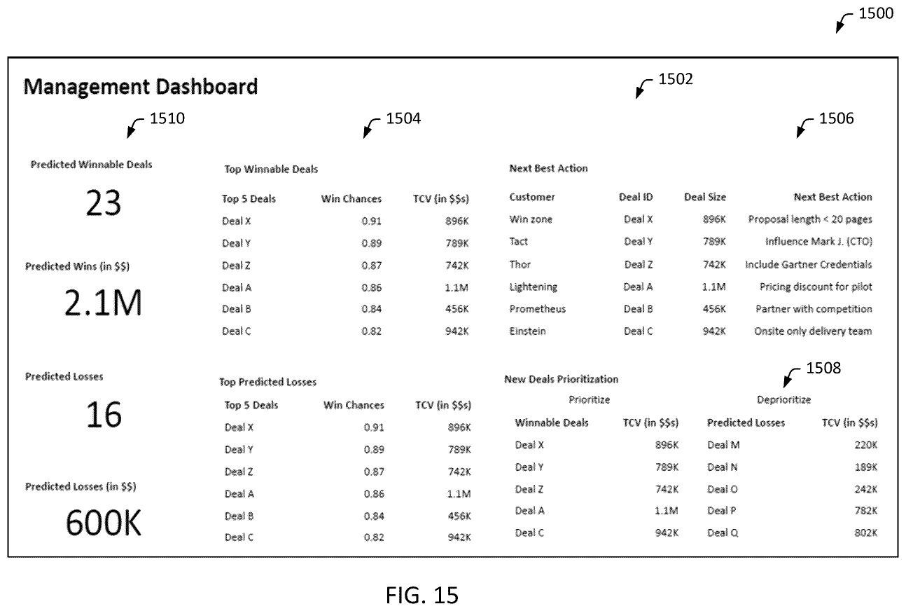

In some embodiments, one or more outcome predictions 152 are communicated to a user, such as a provider 104. For example, CRM engine 110 may serve to a computer of a provider 104, cycle (or “deal”) management content, including an indication of one or more outcome predictions 152, for presentation to provider 104 via a graphical user interface (GUI) of the computer. FIG. 15 is a diagram that illustrates a management dashboard 1500 in accordance with one or more embodiments. In the illustrated embodiment, management dashboard 1500 includes cycle (or “deal”) management content 1502 that includes cycle (or “deal”) status information 1504, cycle (or “deal”) recommendation information 1506, cycle (or “deal”) prioritization information 1508, and a cycle (or “deal”) summary 1510. The deal status information 1504 includes listing of probabilities (or “win chances”) for various deals, for example, determined using the techniques described here. The deal recommendation information 1504 includes listing of deals and associated recommend actions (or “next best actions”) therefore, for example, determined using the techniques described here. The deal prioritization information 1508 includes listing of deals to prioritize (e.g., deals with low value or win chances) and de-prioritize (e.g., deals with high value or win chances). The deal summary 1510 includes an indication of predicted wins, losses and dollar values associated therewith. Such a dashboard may provide a user with a concise view of pending deals and associated attributes, which enables the user to prioritize and take actions to advance deals to an improved outcome, which can, in turn, help to increase performance a profitability of the deal teams and the business as a whole.

Concerning machine learning algorithms described, a given algorithm may be implemented based on its operation and characteristics. For example, Naive Bayes classification may assume independence between features, which may make it suitable for simple datasets with categorical features. Decision tree modeling may recursively split data based on feature values, which may make it effective for capturing complex decision-making processes with both categorical and numerical features. SVM modeling may find a hyperplane that maximally separates classes in a high-dimensional space, which may make it beneficial when a clear margin of separation exists. KNN modeling may classify a data point based on the majority class of its k nearest neighbors, which may benefit tasks emphasizing local similarity. Neural network modeling may create layers of interconnected nodes to learn hierarchical representations, which may be suitable for capturing complex, non-linear relationships in large datasets. Ensemble learning may combine predictions from multiple models to enhance overall performance, which may utilize techniques like bagging or boosting to boost accuracy and robustness. Logistic regression modeling may model the probability that a given instance belongs to a particular category, which may make it useful for problems requiring a probabilistic interpretation. Gradient boosting may build trees sequentially, with each tree correcting the errors of the previous ones and may be effective for combining weak learners to create a strong predictive model. XGBoost may be an ensemble learning technique suitable for handling both historical data and current availability features. Unsupervised Clustering may be a method where the AI system groups data points into clusters based on similarities without pre-labeled categories or guidance, allowing for the identification of inherent patterns or structures within the data. FCM Clustering (Fuzzy C-Means Clustering) may be an AI technique that assigns each data point to one or more clusters with varying degrees of membership, providing a more nuanced grouping compared to hard clustering methods. Cluster Profiling may be a process where the AI system characterizes and summarizes the properties or attributes of each identified cluster, providing insights into the defining features of the groupings. Cluster Tagging may be the practice of labeling or annotating the identified clusters with meaningful tags or descriptors, facilitating easier interpretation and understanding of the different groupings by end-users. Advanced Visualization may be a technique used by AI systems to present complex data and insights through visually engaging and intuitive formats, enhancing the ability to perceive and comprehend intricate patterns and relationships in the data.

In some embodiments, training of CRM models 116 includes pre-processing of historical CRM data 160 or other CRM model training data used to train the models 116, including historical unstructured CRM data 136 and historical structured CRM data 132, used to train a CRM model 116. This may include, for example, removing irrelevant information (e.g., filtering out data that is not relevant to the model's objectives), standardizing data formats (e.g., converting data from various sources into a standard format), handling missing data (e.g., addressing gaps in the data, either by filling in missing values with estimated figures or by excluding incomplete records), data normalization (e.g., scaling the data to a specific range or format), natural language processing (“NLP”) techniques (e.g., parsing language, identifying key phrases or sentiment, and categorizing content based on context), and noise reduction (e.g., removing or minimizing inconsistencies and random fluctuations in the data that can lead to inaccuracies in a model's output). In some embodiments, a CRM model 116 is designed to integrate the pre-processing and processing steps into a single, unified operation.

In some embodiments, training of a CRM model 116 includes splitting transaction model training data, such as historical CRM data 160, into a training data subset, a validation data subset, and a testing data subset. In such an embodiment, the training dataset may be used to train the machine learning model. During this phase, the model may learn patterns and relationships within the data. For example, the algorithm may process the training data, adjusting its parameters to minimize differences between its predicted output and the actual target values. This may be an iterative process that continues until the model achieves satisfactory performance. The validation dataset may be used to fine-tune the model and optimize its hyperparameters. This may provide an independent dataset not used during training to assess how well the model generalizes to new, unseen data. During this phase, after each training iteration, the model's performance is evaluated on the validation set. Based on this evaluation, hyperparameters (e.g., learning rate, regularization, etc.) may be adjusted to improve performance without overfitting to the training data. The testing dataset may be used to assess the model's final performance and generalization to new, unseen data. It may provide an unbiased evaluation of the model's ability to make predictions on data it has never encountered before. During this phase, the model, with its optimized parameters, may be evaluated on the testing set, and its performance metrics (e.g., accuracy, precision, recall, etc.) may be calculated. This evaluation may help to estimate how well the model is expected to perform on new, real-world data. Such evaluations and fine-tune may provide relatively accurate models and associated predictions. For example, models may reach accuracies of 80% or better, which can improve over time with supplemental training data and retraining.

Although embodiments, are described with reference to certain types of training data, modeling, and predictions (or “forecasting”) for certain types and portions of sales cycles, CRM modeling may be conducted, and associated CRM models 116 may be generated, for various types of types and portions of cycles. For instance, an embodiment may include modeling, and implementation of modeling, generated for various portions and stages of a product design cycle, such as product conception, product design, product testing, product sale and implementation and the like that is trained based on historical product design data sourced from prior product design cycles. Although embodiments are described in the context of certain types of data, such as unstructured text of e-mail communications or structured attribute-value pairs of sales cycles, as input vectors, other embodiments may employ any suitable combinations of one or more inputs, such as news articles including unstructured data defining current events, social media posts including unstructured data indicative of industry sentiment, market reports including structured data concerning economic indicators, or the like, in any suitable format.

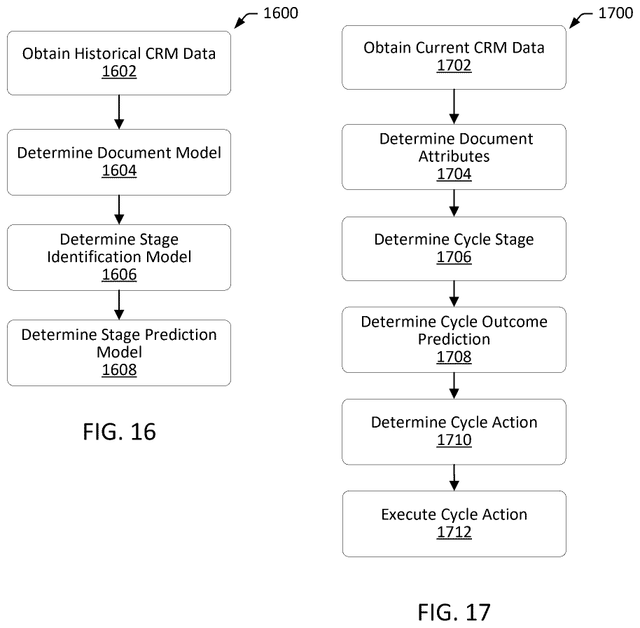

FIG. 16 is a flowchart diagram that illustrates a method 1600 of determining cycle (e.g., CRM) models in accordance with one or more embodiments. Some or all of the procedural elements of method 1600 may be performed, for example, by CRM engine 110 (e.g., by training module 122) or another entity.

Method 1600 may include obtaining historical CRM data (block 1602). This may include obtaining historical CRM data for use in training one or more CRM models. For example, obtaining historical CRM data may include training module 122 obtaining historical CRM data 160 that includes historical structured CRM data 132 (e.g., observed attribute-value pairs for sales cycle attributes of sales cycles) and historical unstructured CRM data 136 (e.g., text of e-mail type documents 150 concerning communications 109 between parties to sales cycles). The historical structured CRM data 132 may, for example, include input data for stage identification modeling (e.g., the structured CRM training data 210 described as input to block 270 of FIG. 2B). The historical unstructured CRM data 136 may, for example, include input data for historical document pre-processing (e.g., the unstructured CRM training data 202 described as input to block 230 of FIG. 2A).

Method 1600 may include determining a document model (block 1604). This may include determining a document model based on obtained historical CRM data. For example, determining a document model may include training module 122 determining, based on obtained unstructured CRM training data 202, a document-to-stage model 258 (e.g., as described with regard to block 256 of FIG. 2A), cluster attributes 248 (e.g., as described with regard to block 246 of FIG. 2A), and document sentiments 250 (e.g., as described with regard to block 248 of FIG. 2A), and determined based thereon, a document model 142 (e.g., as described with regard to block 264 of FIG. 2A).

Method 1600 may include determining a stage identification model (block 1606). This may include determining a stage identification model based on obtained historical CRM data. For example, determining a stage identification model may include training module 122 determining, based on obtained structured CRM training data 210, a stage identification model 146 (e.g., as described with regard to block 270 of FIG. 2B).

Method 1600 may include determining a stage prediction model (block 1608). This may include determining a stage prediction model based on obtained historical CRM data. For example, determining a stage prediction model may include training module 122 determining, based on a stage identification model 146 (e.g., determined based on structured training data 210) at block 270 of FIG. 2B) and document sentiments 250 (e.g., determined based on unstructured training data 202) at block 248 of FIG. 2B), a stage prediction model 144.

FIG. 17 is a flowchart diagram that illustrates a method of managing cycles in accordance with one or more embodiments. Some or all of the procedural elements of method 1700 may be performed, for example, by CRM engine 110 (e.g., by assessment module 124) or another entity.

Method 1700 may include obtaining current CRM data (block 1702). This may include obtaining current CRM data for use in assessing a current cycle, such as a sales (or “deal”) cycle. For example, obtaining current CRM data may include assessment module 124 current CRM data 162 that includes current structured CRM data 134 (e.g., observed attribute-value pairs for sales cycle attributes for a sales cycle over a recent interval of time) and current unstructured CRM data 138 (e.g., text of e-mail type documents 150 concerning recent communications 109 between parties to the sales cycle over the recent interval of time). The current structured CRM data 134 may, for example, include input data for stage identification (e.g., the current structured CRM data 218 described as input to block 290 of FIG. 2B). The current unstructured CRM data 136 may, for example, include input data for document attribute assessment (e.g., the current unstructured CRM data 214 described as input to block 280 of FIG. 2A).

Method 1700 may include determining document attributes (block 1704). This may include applying current CRM data to a document model to determine current document attributes. For example, determining document attributes may include assessment module 124 applying current unstructured CRM data 214 (or current document vectors derived therefrom) to a document model 142 to determine current document attributes 286 (e.g., as described with regard to deal unstructured pathway 216 and blocks 280 and 284 of FIG. 2A).

Method 1700 may include determining a cycle stage (block 1706). This may include applying current CRM data to a stage identification model to determine a current stage of the associated cycle. For example, determining a cycle stage may include assessment module 124 applying current structured CRM data 218 to a stage identification model 146 to determine current stage identification 292 (e.g., as described with regard to deal structured pathway 220 and block 290 of FIG. 2B).

Method 1700 may include determining a cycle outcome prediction (block 1708). This may include applying a set of current attributes and a current stage to a stage prediction model to determine an outcome prediction for an associated cycle. For example, determining a cycle outcome prediction may include assessment module 124 applying a stage identification 292 and current documents attributes 286 to a stage prediction model 294 to determine an outcome prediction for the associated sales cycle (e.g., as described with regard to block 294 of FIG. 2B).

Method 1700 may include determining a cycle action (block 1710). This may include determining, based on a cycle outcome prediction, an action to be taken to, for example, enhance the outcome of an associated cycle. For example, determining a cycle action may include assessment module 124 identifying one or more recommended actions defined in a CRM plan 156 of an outcome prediction 152 (e.g., “Action=Contacting the client by phone to discuss modifying the letter of intent to preemptively address a range of sales price to be negotiated”).

Method 1700 may include executing a cycle action (block 1712). This may include executing an action to be taken to, for example, enhance the outcome of an associated cycle. For example, executing a cycle action may include an entity (e.g., provider 104, CRM engine 110, or the like) taking action in accordance with a recommended action defined in a CRM plan 156 of an outcome prediction 152 (e.g., provider 104 may, in response to the outcome prediction 152, call customer 106 by phone to discuss modifying the LOI to preemptively set a range of the ultimate sales price to be negotiated, which may, in turn, help facilitate completion of the negotiations stage).

As described, embodiments may assist in management of cycles, including identifying opportunities to generate an improved outcome for cycles. For example, where an outcome prediction determines that a sales cycle will reach a given stage that is short of a win, an outcome prediction (e.g., generated based on the modeling and application of data described herein) may indicate a given stage that the sales cycle is predicted to reach and a CRM plan that defines one or more recommended “next best actions” to be taken to enhance the likelihood of the sales cycle advancing past the given stage, to a win scenario.

FIG. 18 is a diagram that illustrates an example computer system (or “system”) 1800 in accordance with one or more embodiments. The system 1800 may include a memory 1804, a processor 1806 and an input/output (I/O) interface 1808. The memory 1804 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1804 may include a non-transitory computer-readable storage medium having program instructions 1810 stored on the medium. The program instructions 1810 may include program modules 1812 that are executable by a computer processor (e.g., the processor 1806) to cause the functional operations described, such as those described with regard to the entities described (e.g., management system 102, CRM engine 110, CRM model training module 122, CRM assessment module 124, provider(s) 104, or customer(s) 106), operational aspects of environment 108, operational aspects of transaction system 102, method 1600 or method 1700.

The processor 1806 may be any suitable processor capable of executing program instructions. The processor 1806 may include one or more processors that carry out program instructions (e.g., the program instructions of the program modules 1812) to perform the arithmetical, logical, or input/output operations described. The processor 1806 may include multiple processors that can be grouped into one or more processing cores that each include a group of one or more processors that are used for executing the processing described here, such as the independent parallel processing of partitions (or “sectors”) by different processing cores. The I/O interface 1808 may provide an interface for communication with one or more I/O devices 1814, such as a joystick, a computer mouse, a keyboard, or a display screen (e.g., an electronic display for displaying a graphical user interface (GUI)). The I/O devices 1814 may include one or more of the user input devices. The I/O devices 1814 may be connected to the I/O interface 1808 by way of a wired connection (e.g., an Industrial Ethernet connection) or a wireless connection (e.g., a Wi-Fi connection). The I/O interface 1808 may provide an interface for communication with one or more external devices 1816, computer systems, servers or electronic communication networks. In some embodiments, the I/O interface 1808 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A method for conducting cycle management comprising:
   determining, based on historical structured CRM data, a stage identification model configured to identify a stage of a sales cycle based on structured CRM data, the historical structured CRM dataset indicative of attributes and stages of a set of historical sales cycles;
   determining, based on historical unstructured CRM data, a document-to-stage model configured to determine a stage of a sales cycle based on textual data of documents associated with the sales cycle, the historical unstructured CRM dataset comprising a set of documents corresponding to the set of historical sales cycles;
   determining sentiments for the set of documents;
   determining document clusters for the set of documents and cluster attributes for the document clusters;
   determining, based on (a) the document-to-stage model, (b) the cluster attributes, and (c) the sentiments for the set of documents, a document model configured to determine document attributes of a set of documents;
   determining, based on (a) stage identification model and (b) the sentiments for the documents, a stage prediction model configured to determine attributes of a current sales cycle based on (i) a current sales cycle stage and (ii) current document attributes;
   determining, based on application of current sales cycle structured data to the stage identification model, a current stage of the current sales cycle, the current sales cycle structured data indicative of attributes of a current stage of a current sales cycles
   determining, based on application of current sales cycle unstructured data, a current set of attributes for the current sales cycle, the current sales cycle unstructured data comprising a set of documents corresponding to the current sales cycle; and
   determining, based on application of (a) the current stage of the current sales cycle and (b) the current set of attributes for the current sales cycle to the stage prediction model, a predicted outcome for the current sales cycle, the predicted outcome indicative of a stage that the current sales cycle is predicted to reach; and
   determining, based on the predicted outcome, a CRM plan configured to generate an improved outcome.
2. The method of embodiment 1, wherein the CRM plan defines a sales cycle action to be taken, the operations further comprising:
   executing, based on the CRM plan, the sales cycle action.
3. A sales management system comprising:
   a customer relationship management (CRM) database configured to store CRM data comprising:
   structured CRM data received from a structured CRM data source and indicative of attributes and stages of sales cycles; and
      unstructured CRM data received from an unstructured CRM data source, and comprising documents comprising textual data corresponding to electronic communications between clients and providers of sales cycles; and
   a CRM engine comprising non-transitory computer readable storage medium comprising program instructions stored thereon that are executable by a processor to perform the following operations for conducting sales management:
      generating, based on the structured CRM data, a historical structured CRM dataset corresponding to a set of historical sales cycles, the historical structured CRM dataset indicative of attributes and stages of the set of historical sales cycles;
      determining, based on the historical structured CRM dataset, a stage identification model configured to identify a stage of a sales cycle based on structured CRM data;
      generating, based on the unstructured CRM data, a historical unstructured CRM dataset corresponding to the set of historical sales cycles, the historical unstructured CRM dataset comprising a set of documents comprising textual data corresponding to electronic communications between one or more clients and one or more providers associated with the set of historical sales cycles;
      determining, for each document of the set of documents:
         a stage of a sales cycle associated with the document; and
         a numerical representation of the document;
      determining, based on the documents, a document-to-stage model configured to determine a stage of a sales cycle based on textual data of documents associated with the sales cycle;
      determining, for each document of the documents, a sentiment for the document;
      determining, based on the numerical representations of the documents, document clusters;
      determining, for each document cluster of the document clusters, a cluster word set for the document cluster;
      determining, for each document cluster of the document clusters based on the cluster word set for the document cluster, cluster attributes;
      determining, based on (a) the document-to-stage model, (b) the cluster attributes, and (c) the sentiments for the documents, a document model configured to determine current document attributes based on numerical representations of a set of current documents;
      determining, based on (a) stage identification model and (b) the sentiments for the documents, a stage prediction model configured to determine attributes of a current sales cycle based on (i) a current sales cycle stage and (ii) current document attributes;
      obtaining a current CRM sales cycle dataset comprising:
         current sales cycle structured data indicative of attributes of a current stage of a current sales cycles;
         current sales cycle unstructured data comprising current documents comprising textual data corresponding to current electronic communications between one or more clients and one or more providers of the current sales cycle;
      determining, based on application of the current sales cycle structured data to the stage identification model, a current stage of the current sales cycle;
      determining, based on the current sales cycle unstructured data, a current set of numerical representations of the current set of documents;
      determining, based on application of the set of the current set of numerical representations of the current set of documents to the document model, a current set of attributes for the current sales cycle; and
      determining, based on application of (a) the current stage of the current sales cycle and (b) the current set of attributes for the current sales cycle to the stage prediction model, a predicted outcome for the current sales cycle, the predicted outcome indicative of a stage that the current sales cycle is predicted to reach; and
      determining, based on the predicted outcome, a CRM plan configured to generate an improved outcome.
4. The system of embodiment 3, wherein the CRM plan defines a sales cycle action to be taken, the operations further comprising:
   executing, based on the CRM plan, the sales cycle action.
5. The system of embodiment 3 or embodiment 4, wherein the stage of the sales cycle associated with a document is determined based on a supervised learning process comprising labeling of the document with the stage of the sales cycle.
6. The system of any one of embodiments 3-5, wherein the numerical representation of the document comprises a vector determined based on vectorization of the textual data of the document.
7. The system of any one of embodiments 3-6, wherein the document-to-stage model comprises one or more of:
   a document-to-vector model configured to determine vectors based on textual data of one or more documents; and
   a vector-to-stage model configured to determine a stage based on vectors comprising numerical representations of documents.
8. The system of any one of embodiments 3-7, wherein the cluster attributes for a document cluster comprises significant words of the cluster word set for the document cluster.
9. The system of any one of embodiments 3-8, wherein the numerical representations of the set of current documents comprise vectors representing the set of current documents.
10. The system of any one of embodiments 3-9, wherein the numerical representations of the current set of documents comprise vectors determined by way of vectorization of the textual data of the current set of documents.
11. A method for conducting sales cycle management comprising:
   obtaining, from a structured CRM data source, structured CRM data indicative of attributes and stages of sales cycles;
   obtaining, from an unstructured CRM data source, unstructured CRM data comprising documents comprising textual data corresponding to electronic communications between clients and providers of sales cycles;
   generating, based on the structured CRM data, a historical structured CRM dataset corresponding to a set of historical sales cycles, the historical structured CRM dataset indicative of attributes and stages of the set of historical sales cycles;
   determining, based on the historical structured CRM dataset, a stage identification model configured to identify a stage of a sales cycle based on structured CRM data;
   generating, based on the unstructured CRM data, a historical unstructured CRM dataset corresponding to the set of historical sales cycles, the historical unstructured CRM dataset comprising a set of documents comprising textual data corresponding to electronic communications between one or more clients and one or more providers associated with the set of historical sales cycles;
   determining, for each document of the set of documents:
      a stage of a sales cycle associated with the document; and
      a numerical representation of the document;
   determining, based on the documents, a document-to-stage model configured to determine a stage of a sales cycle based on textual data of documents associated with the sales cycle;
   determining, for each document of the documents, a sentiment for the document;
   determining, based on the numerical representations of the documents, document clusters;
   determining, for each document cluster of the document clusters, a cluster word set for the document cluster;
   determining, for each document cluster of the document clusters based on the cluster word set for the document cluster, cluster attributes;
   determining, based on (a) the document-to-stage model, (b) the cluster attributes, and (c) the sentiments for the documents, a document model configured to determine current document attributes based on numerical representations of a set of current documents;
   determining, based on (a) stage identification model and (b) the sentiments for the documents, a stage prediction model configured to determine attributes of a current sales cycle based on (i) a current sales cycle stage and (ii) current document attributes;
   obtaining a current CRM sales cycle dataset comprising:
      current sales cycle structured data indicative of attributes of a current stage of a current sales cycles;
      current sales cycle unstructured data comprising current documents comprising textual data corresponding to current electronic communications between one or more clients and one or more providers of the current sales cycle;
   determining, based on application of the current sales cycle structured data to the stage identification model, a current stage of the current sales cycle;
   determining, based on the current sales cycle unstructured data, a current set of numerical representations of the current set of documents;
   determining, based on application of the set of the current set of numerical representations of the current set of documents to the document model, a current set of attributes for the current sales cycle; and
   determining, based on application of (a) the current stage of the current sales cycle and (b) the current set of attributes for the current sales cycle to the stage prediction model, a predicted outcome for the current sales cycle, the predicted outcome indicative of a stage that the current sales cycle is predicted to reach; and
   determining, based on the predicted outcome, a CRM plan configured to generate an improved outcome.
12. The method of embodiment 11, wherein the CRM plan defines a sales cycle action to be taken, the operations further comprising:
   executing, based on the CRM plan, the sales cycle action.
13. The method of embodiment 11 or embodiment 12, wherein the stage of the sales cycle associated with a document is determined based on a supervised learning process comprising labeling of the document with the stage of the sales cycle.
14. The method of any one of embodiments 11-13, wherein the numerical representation of the document comprises a vector determined based on vectorization of the textual data of the document.
15. The method of any one of embodiments 11-14, wherein the document-to-stage model comprises one or more of:
   a document-to-vector model configured to determine vectors based on textual data of one or more documents; and
   a vector-to-stage model configured to determine a stage based on vectors comprising numerical representations of documents.
16. The method of any one of embodiments 11-15, wherein the cluster attributes for a document cluster comprises significant words of the cluster word set for the document cluster.
17. The method of any one of embodiments 11-16, wherein the numerical representations of the set of current documents comprise vectors representing the set of current documents.
18. The method of any one of embodiments 11-17, wherein the numerical representations of the current set of documents comprise vectors determined by way of vectorization of the textual data of the current set of documents.
19. A non-transitory computer readable storage medium comprising program instructions stored thereon that are executable by a processor to perform the operations of any one of embodiments 1-18.

1. A sales management system comprising:
a customer relationship management (CRM) database configured to store CRM data comprising:
structured CRM data received from a structured CRM data source and indicative of attributes and stages of sales cycles; and
unstructured CRM data received from an unstructured CRM data source, and comprising documents comprising textual data corresponding to electronic communications between clients and providers of sales cycles; and
a CRM engine comprising non-transitory computer readable storage medium comprising program instructions stored thereon that are executable by a processor to perform the following operations for conducting sales management:
generating, based on the structured CRM data, a historical structured CRM dataset corresponding to a set of historical sales cycles, the historical structured CRM dataset indicative of attributes and stages of the set of historical sales cycles;
determining, based on the historical structured CRM dataset, a stage identification model configured to identify a stage of a sales cycle based on structured CRM data;
generating, based on the unstructured CRM data, a historical unstructured CRM dataset corresponding to the set of historical sales cycles, the historical unstructured CRM dataset comprising a set of documents comprising textual data corresponding to electronic communications between one or more clients and one or more providers associated with the set of historical sales cycles;
determining, for each document of the set of documents:
a stage of a sales cycle associated with the document; and
a numerical representation of the document;
determining, based on the documents, a document-to-stage model configured to determine a stage of a sales cycle based on textual data of documents associated with the sales cycle;
determining, for each document of the documents, a sentiment for the document;
determining, based on the numerical representations of the documents, document clusters;
determining, for each document cluster of the document clusters, a cluster word set for the document cluster;
determining, for each document cluster of the document clusters based on the cluster word set for the document cluster, cluster attributes;
determining, based on (a) the document-to-stage model, (b) the cluster attributes, and (c) the sentiments for the documents, a document model configured to determine current document attributes based on numerical representations of a set of current documents;
determining, based on (a) stage identification model and (b) the sentiments for the documents, a stage prediction model configured to determine attributes of a current sales cycle based on (i) a current sales cycle stage and (ii) current document attributes;
obtaining a current CRM sales cycle dataset comprising:
current sales cycle structured data indicative of attributes of a current stage of a current sales cycles;
current sales cycle unstructured data comprising current documents comprising textual data corresponding to current electronic communications between one or more clients and one or more providers of the current sales cycle;
determining, based on application of the current sales cycle structured data to the stage identification model, a current stage of the current sales cycle;
determining, based on the current sales cycle unstructured data, a current set of numerical representations of the current set of documents;
determining, based on application of the set of the current set of numerical representations of the current set of documents to the document model, a current set of attributes for the current sales cycle; and
determining, based on application of (a) the current stage of the current sales cycle and (b) the current set of attributes for the current sales cycle to the stage prediction model, a predicted outcome for the current sales cycle, the predicted outcome indicative of a stage that the current sales cycle is predicted to reach; and
determining, based on the predicted outcome, a CRM plan configured to generate an improved outcome.

2. The system of claim 1, wherein the CRM plan defines a sales cycle action to be taken, the operations further comprising:
executing, based on the CRM plan, the sales cycle action.

3. The system of claim 1, wherein the stage of the sales cycle associated with a document is determined based on a supervised learning process comprising labeling of the document with the stage of the sales cycle.

4. The system of claim 1, wherein the numerical representation of the document comprises a vector determined based on vectorization of the textual data of the document.

5. The system of claim 1, wherein the document-to-stage model comprises one or more of:
a document-to-vector model configured to determine vectors based on textual data of one or more documents; and
a vector-to-stage model configured to determine a stage based on vectors comprising numerical representations of documents.

6. The system of claim 1, wherein the cluster attributes for a document cluster comprises significant words of the cluster word set for the document cluster.

7. The system of claim 1, wherein the numerical representations of the set of current documents comprise vectors representing the set of current documents.

8. The system of claim 1, wherein the numerical representations of the current set of documents comprise vectors determined by way of vectorization of the textual data of the current set of documents.

9. A method for conducting sales cycle management comprising:
obtaining, from a structured CRM data source, structured CRM data indicative of attributes and stages of sales cycles;
obtaining, from an unstructured CRM data source, unstructured CRM data comprising documents comprising textual data corresponding to electronic communications between clients and providers of sales cycles;
generating, based on the structured CRM data, a historical structured CRM dataset corresponding to a set of historical sales cycles, the historical structured CRM dataset indicative of attributes and stages of the set of historical sales cycles;
determining, based on the historical structured CRM dataset, a stage identification model configured to identify a stage of a sales cycle based on structured CRM data;
generating, based on the unstructured CRM data, a historical unstructured CRM dataset corresponding to the set of historical sales cycles, the historical unstructured CRM dataset comprising a set of documents comprising textual data corresponding to electronic communications between one or more clients and one or more providers associated with the set of historical sales cycles;
determining, for each document of the set of documents:
a stage of a sales cycle associated with the document; and
a numerical representation of the document;
determining, based on the documents, a document-to-stage model configured to determine a stage of a sales cycle based on textual data of documents associated with the sales cycle;
determining, for each document of the documents, a sentiment for the document;
determining, based on the numerical representations of the documents, document clusters;
determining, for each document cluster of the document clusters, a cluster word set for the document cluster;
determining, for each document cluster of the document clusters based on the cluster word set for the document cluster, cluster attributes;
determining, based on (a) the document-to-stage model, (b) the cluster attributes, and (c) the sentiments for the documents, a document model configured to determine current document attributes based on numerical representations of a set of current documents;
determining, based on (a) stage identification model and (b) the sentiments for the documents, a stage prediction model configured to determine attributes of a current sales cycle based on (i) a current sales cycle stage and (ii) current document attributes;
obtaining a current CRM sales cycle dataset comprising:
current sales cycle structured data indicative of attributes of a current stage of a current sales cycles;
current sales cycle unstructured data comprising current documents comprising textual data corresponding to current electronic communications between one or more clients and one or more providers of the current sales cycle;
determining, based on application of the current sales cycle structured data to the stage identification model, a current stage of the current sales cycle;
determining, based on the current sales cycle unstructured data, a current set of numerical representations of the current set of documents;
determining, based on application of the set of the current set of numerical representations of the current set of documents to the document model, a current set of attributes for the current sales cycle; and
determining, based on application of (a) the current stage of the current sales cycle and (b) the current set of attributes for the current sales cycle to the stage prediction model, a predicted outcome for the current sales cycle, the predicted outcome indicative of a stage that the current sales cycle is predicted to reach; and
determining, based on the predicted outcome, a CRM plan configured to generate an improved outcome.

10. The method of claim 9, wherein the CRM plan defines a sales cycle action to be taken, the operations further comprising:
executing, based on the CRM plan, the sales cycle action.

11. The method of claim 9, wherein the stage of the sales cycle associated with a document is determined based on a supervised learning process comprising labeling of the document with the stage of the sales cycle.

12. The method of claim 9, wherein the numerical representation of the document comprises a vector determined based on vectorization of the textual data of the document.

13. The method of claim 9, wherein the document-to-stage model comprises one or more of:
a document-to-vector model configured to determine vectors based on textual data of one or more documents; and
a vector-to-stage model configured to determine a stage based on vectors comprising numerical representations of documents.

14. The method of claim 9, wherein the cluster attributes for a document cluster comprises significant words of the cluster word set for the document cluster.

15. The method of claim 9, wherein the numerical representations of the set of current documents comprise vectors representing the set of current documents.

16. The method of claim 9, wherein the numerical representations of the current set of documents comprise vectors determined by way of vectorization of the textual data of the current set of documents.

17. A non-transitory computer readable storage medium comprising program instructions stored thereon that are executable by a processor to perform the following operations for item transactions:
obtaining, from a structured CRM data source, structured CRM data indicative of attributes and stages of sales cycles;
obtaining, from an unstructured CRM data source, unstructured CRM data comprising documents comprising textual data corresponding to electronic communications between clients and providers of sales cycles;
generating, based on the structured CRM data, a historical structured CRM dataset corresponding to a set of historical sales cycles, the historical structured CRM dataset indicative of attributes and stages of the set of historical sales cycles;
determining, based on the historical structured CRM dataset, a stage identification model configured to identify a stage of a sales cycle based on structured CRM data;
generating, based on the unstructured CRM data, a historical unstructured CRM dataset corresponding to the set of historical sales cycles, the historical unstructured CRM dataset comprising a set of documents comprising textual data corresponding to electronic communications between one or more clients and one or more providers associated with the set of historical sales cycles;
determining, for each document of the set of documents:
a stage of a sales cycle associated with the document; and
a numerical representation of the document;
determining, based on the documents, a document-to-stage model configured to determine a stage of a sales cycle based on textual data of documents associated with the sales cycle;
determining, for each document of the documents, a sentiment for the document;
determining, based on the numerical representations of the documents, document clusters;
determining, for each document cluster of the document clusters, a cluster word set for the document cluster;
determining, for each document cluster of the document clusters based on the cluster word set for the document cluster, cluster attributes;
determining, based on (a) the document-to-stage model, (b) the cluster attributes, and (c) the sentiments for the documents, a document model configured to determine current document attributes based on numerical representations of a set of current documents;
determining, based on (a) stage identification model and (b) the sentiments for the documents, a stage prediction model configured to determine attributes of a current sales cycle based on (i) a current sales cycle stage and (ii) current document attributes;
obtaining a current CRM sales cycle dataset comprising:
current sales cycle structured data indicative of attributes of a current stage of a current sales cycles;
current sales cycle unstructured data comprising current documents comprising textual data corresponding to current electronic communications between one or more clients and one or more providers of the current sales cycle;
determining, based on application of the current sales cycle structured data to the stage identification model, a current stage of the current sales cycle;
determining, based on the current sales cycle unstructured data, a current set of numerical representations of the current set of documents;
determining, based on application of the set of the current set of numerical representations of the current set of documents to the document model, a current set of attributes for the current sales cycle; and
determining, based on application of (a) the current stage of the current sales cycle and (b) the current set of attributes for the current sales cycle to the stage prediction model, a predicted outcome for the current sales cycle, the predicted outcome indicative of a stage that the current sales cycle is predicted to reach; and
determining, based on the predicted outcome, a CRM plan configured to generate an improved outcome.
